(19) United States
(12) Patent Application Publication
(10) Pub. No.: US 2020/0056994 A1
(43) Pub. Date: Feb. 20, 2020

(54) FLUORESCENT SILANE LAYERS FOR DETECTING EXPLOSIVES

(71) Applicant: Institut Dr. Foerster GmbH & Co. KG, Reutlingen (DE)

(72) Inventors: Knut Rurack, Berlin (DE); Mustafa Biyikal, Reutlingen (DE)

(73) Assignee: Institut Dr. Foerster GmbH & Co. KG, Reutlingen (DE)

(21) Appl. No.: 16/487,448

(22) PCT Filed: Feb. 21, 2018
(86) PCT No.: PCT/EP2018/054287

§ 371 Date: Aug. 21, 2019

(30) Foreign Application Priority Data
Feb. 21, 2017 (DE) 102017103535.4

(51) Int. Cl. G01N 21/64; C06B 47/00; C09K 11/06; G01N 31/22; G01N 1/40

(52) U.S. Cl. CPC G01N 21/643; C06B 47/00; C09K 11/06; G01N 21/6408; G01N 1/4022; G01N 2021/6432; G01N 31/22

(57) ABSTRACT

Detection reagent for an analyte comprising an NOₓ group, wherein the detection reagent comprises an arylamine, and a structural formula of the arylamine is selected from the structural formulae 1, 2 and 3:

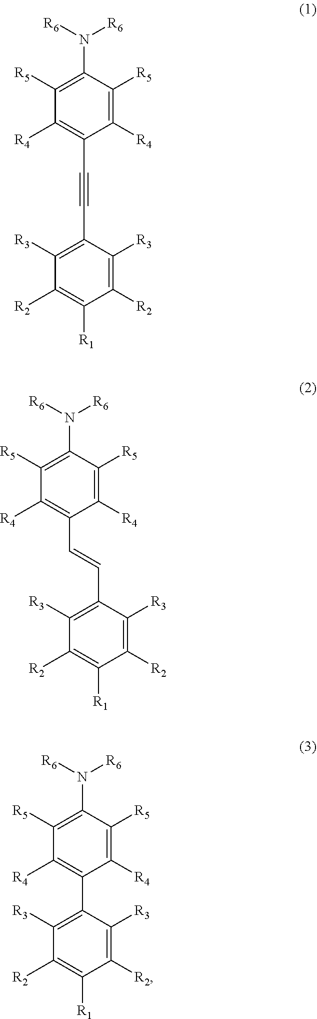

or of the formulae 4 or 5:

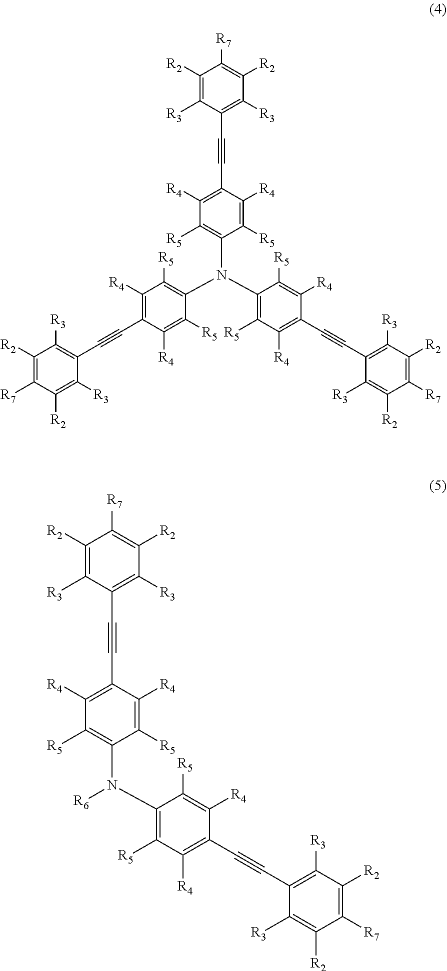

where R₁ and R₇ are selected from CO₂or PhCO₂X with X=4-iodophenyl; 4-bromophenyl or 4-chlorophenyl; 4-vinylphenyl or 4-allylphenyl; or

R₁ and R₇ are selected from CO₂Y or PhCO₂Y with Y=2-methyl-3-pentyn-2-yl or 3-tert-butyl-4,4-dimethyl-1-pentyn-3-yl, or R₇ is selected from CO₂Z, PhCO₂Z, C(O)NZ₂ or PhC(O)NZ₂ with (Z=alkyl, perfluoroalkyl, vinyl, allyl, homoallyl, aryl); where R₂, R₃, R₄, and/or R₅ are independently selected from H, F, an alkyl and an aryl; and where R₆ is selected from an alkyl and an aryl.

### BACKGROUND OF THE INVENTION

The invention is in the field of the detection of analytes comprising at least one NOx group and relates more particularly to the detection of explosives and marker substances for explosives with the aid of optically analyzable indicator layers.

Explosives of practical relevance and marker substances used for marking thereof include compounds based on NOx. Compounds of relevance for trace analysis are, for example, TNT (2,4,6-trinitrotoluene), DNT (2,4-dinitrotoluene and 2,6-dinitrotoluene), tetryl (2,4,6-trinitrophenylmethylnitramine), PETN (nitropenta), NG (nitroglycerine), EGDN (ethylene glycol dinitrate), RDX (hexahydro-1,3,5-trinitro-1,3,5-triazine), HMX (octahydro-1,3,5,7-tetranitro-1,3,5,7-tetrazocine), NH₄NO₃ (ammonium nitrate) and DMDNB (2,3-dimethyl-2,3-dinitrobutane—a marker substance). In the security, military and environmental sector, on-site detection of these compounds is of major practical significance. Most systems currently being supplied on the market for detection of explosives are based on ion mobility spectrometry (IMS), gas chromatography (GC) or Raman spectroscopy- and infrared (IR) spectroscopy-based measurement technology. Commercial significance has been gained in particular by IMS devices (e.g. SABRE 4000, Smiths Detection/USA) and Raman devices (e.g. FirstDefender™, Ahura/USA). Moreover, for detection of explosives, the use of chemical methods based on chemiluminescence assays or sensors that interact at the molecular level, such as fluorescent conjugated polymers, known as “amplifying fluorescent polymers” (AFPs), has been described. Other compounds based on NOx that are of relevance for trace analysis are, for example, pesticides and the residues and degradation products (metabolites) thereof.

As well as the space required for the instruments that are typically non-portable and hence require particular conditions, the known methods have further disadvantages:
(i) IMS is based on a radioactive source and often has disadvantageous drift behavior.
(ii) GC techniques require a carrier gas reservoir.
(iii)Raman spectrometers typically require a connection to the power grid, i.e. are not battery-operated, and are prone to non-specific fluorescence.
(iv) Laser-based methods are usually likewise not battery-operated and are frequently subject to strong matrix effects.

### SUMMARY OF THE INVENTION

Against this background, a detection reagent, a method of detecting an analyte comprising an NOx group, a production method for an analyte-sensitive layer, an analyte-sensitive layer and the use of a detection reagent for monitoring a threshold for an explosive are proposed and disclosed herein. Further embodiments, modifications and improvements are apparent from the description that follows and the claims appended.

In a first embodiment, a detection reagent for an analyte comprising an NO. group is proposed, wherein the detection reagent comprises an arylamine, and a structural formula of the arylamine is selected from the following structural formulae 1, 2 and 3:

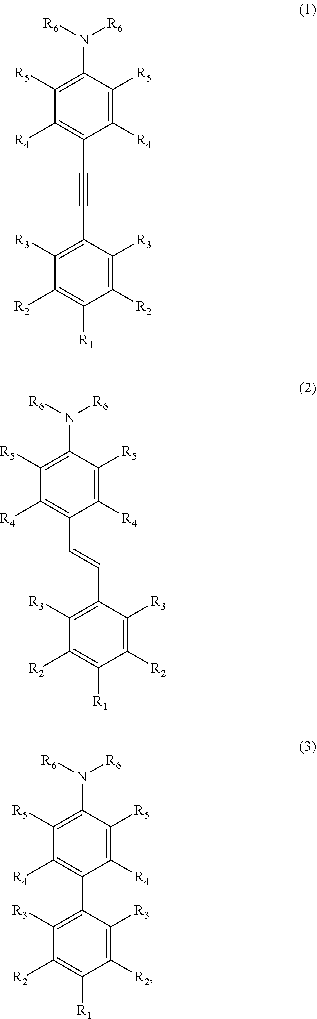

or from the formulae 4 and 5:

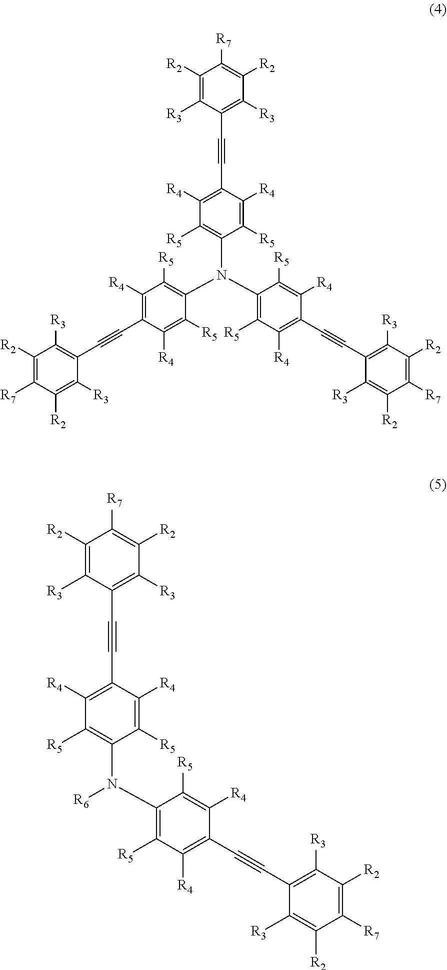

R₁ and R₇ here are selected from CO₂X or PhCO₂X with X=4-iodophenyl; 4-bromophenyl, 4-chlorophenyl, 4-vinylphenyl, or 4-allylphenyl; or R₁ and R₇ are selected from CO₂Y or PhCO₂Y with Y=2-methyl-3-pentyn-2-yl or 3-tert-butyl-4,4-dimethyl-1-pentyn-3-yl or R₇ is selected from CO₂Z, PhCO₂Z, C(O)NZ₂ or PhC(O)NZ₂ with Z=alkyl, perfluoroalkyl, vinyl, allyl, homoallyl and aryl.

Independently of that, R₂, R₃, R₄, and/or R₅ are—each independently—selected from H, F, an alkyl and an aryl; and R₆ is selected from an alkyl and an aryl.

Advantageously, CO₂X can be converted by means of Heck reaction or metathesis reaction with a reactive organosilane, for example with trimethoxy(4-vinylphenyl)silane or (styryl)trimethoxysilane (cf. FIG. 2). The organosilanes can also be used here in excess. The silane dye formed or the reaction mixture can be reacted with the glass surface or silicate nanoparticles. Alternatively, the detection reagent can simply be adsorbed onto glass via the CO₂X, PhCO₂X, CO₂Y, PhCO₂Y, CO₂Z, PhCO₂Z or C(O)NY₂ group. The excess of organosilanes is advantageous because this prevents the self-quenching effect via an increased distance of the dye molecules from one another.

In a further embodiment, R₂, R₃, R₄ and R₅ radicals in the detection reagent are hydrogen.

Advantageously, the resulting compounds react to the presence of NOx-containing analytes with a reproducible change in at least one fluorescence property.

In a further embodiment, the R₆ radical is a phenyl group and the resulting arylamine thus comprises a triphenylamine motif.

Advantages of the resulting triphenylamine motif relate to electron abstraction and are described in more detail further down.

In a further embodiment, the triphenylamine motif is covalently bonded to a phenyl group in at least one and not more than three para positions, and remaining para positions are either unsubstituted or methylated.

Advantages arise with the facilitated electron abstraction or absorption in the presence of a corresponding analyte.

In a further embodiment, the triphenylamine motif is joined to the phenyl group via a triple bond, via a double bond or via a single bond.

The advantages that result therefrom relate to the aspects already named as advantageous above.

In a further embodiment, the structural formula of the arylamine is selected from a triphenylamine compound of the structural formulae 6.1 to 6.5:

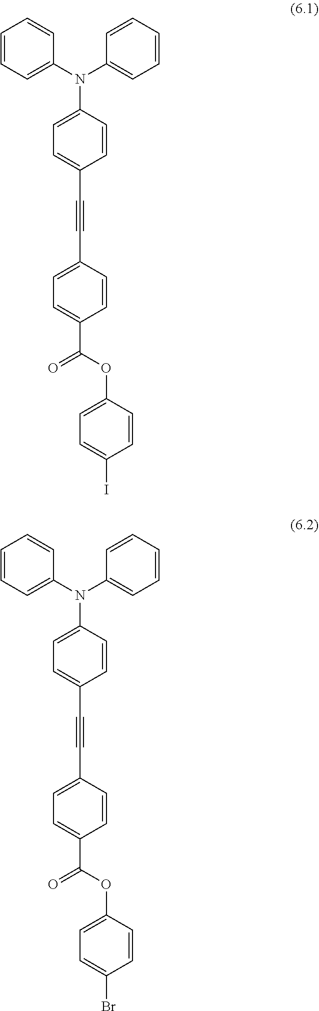 [SMILES: O=C(Oc1ccc(I)cc1)c1ccc(C#Cc2ccc(N(c3ccccc3)c3ccccc3)cc2)cc1 ; O=C(Oc1ccc(Br)cc1)c1ccc(C#Cc2ccc(N(c3ccccc3)c3ccccc3)cc2)cc1]

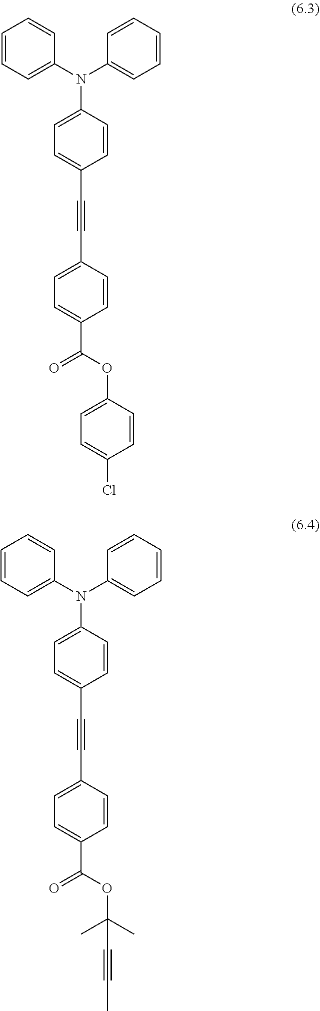 [SMILES: O=C(Oc1ccc(Cl)cc1)c1ccc(C#Cc2ccc(N(c3ccccc3)c3ccccc3)cc2)cc1 ; CC#CC(C)(C)OC(=O)c1ccc(C#Cc2ccc(N(c3ccccc3)c3ccccc3)cc2)cc1]

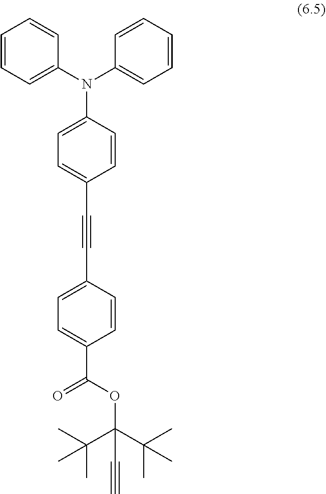 [SMILES: C#CC(OC(=O)c1ccc(C#Cc2ccc(N(c3ccccc3)c3ccccc3)cc2)cc1)(C(C)(C)C)C(C)(C)C]

Analogously to the esters 6.1 to 6.5, suitable detection reagents for the analytes (explosives) described are the esters and amides of compound 4, for example of the formula 4.1 shown below:

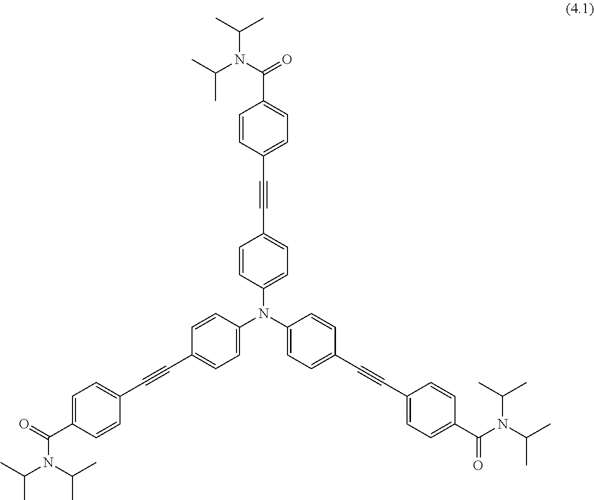 [SMILES: CC(C)N(C(=O)c1ccc(C#Cc2ccc(N(c3ccc(C#Cc4ccc(C(=O)N(C(C)C)C(C)C)cc4)cc3)c3ccc(C#Cc4ccc(C(=O)N(C(C)C)C(C)C)cc4)cc3)cc2)cc1)C(C)C]

The triphenylamine motif, as a donor, releases an electron to the NOₓ group of the analyte or, as a receptor, accepts an electron from the NOx group of the analyte. In the case of release of the electron to the NOx group of the analyte, quenching of fluorescence from the detection reagent is measurable, and so the analyte is optically determinable qualitatively and/or at least semi-quantitatively.

In a further embodiment, the analyte comprising the NOₓ group is selected from: TNT, DNT, tetryl, PETN, NG, EGDN, DNDMB, ammonium nitrate, RDX and HMX.

In a further embodiment, the analyte comprising the NOx group is present in a sample comprising an organic solution, an aqueous solution, a mixed organic-aqueous solution, an air sample and/or a wiped sample.

Advantageously, the abovementioned explosives can be detected from a wide variety of different samples with the detection reagent described.

In a further embodiment, R₁ and R₇ in the detection reagent are selected from CO₂X or PhCO₂X with X=4-iodophenyl; 4-bromophenyl or 4-chlorophenyl, such that the detection reagent, after a reaction with a reactive organosilane by means of a Heck reaction, can be bonded covalently to a substrate and/or can form a monomolecular layer over at least parts of the substrate.

Advantageously, the formation of a monomolecular layer promotes the homogeneity of a fluorescence signal from a surface of the substrate coated with the detection reagent.

In a further embodiment, R₁ and R₇ in the detection reagent are selected from CO₂Y, PhCO₂Y, with Y=2-methyl-3-pentyn-2-yl or 3-tert-butyl-4,4-dimethyl-1-pentyn-3-yl and, in a further embodiment, R₇ is CO₂Z, PhCO₂Z, C(O)NZ₂ or PhC(O)NZ₂ with Z=alkyl, perfluoroalkyl, vinyl, allyl, homoallyl and aryl and the detection reagent has been adsorbed directly on at least parts of the substrate, where there is no polymer between substrate and adsorbed detection reagent.

Advantages of these substituents are that aggregation of the molecules of the detection reagent on a substrate surface and self-quenching of fluorescence are prevented.

In a further embodiment, the substrate comprises a silicatic material or is a silicate glass.

Advantageously, silicatic materials such as silicon, mineral glasses and silicate glass, primarily borosilicate glass, have silanol groups or are capable of forming silanol groups.

In a further embodiment, the reactive organosilane is selected from: a trimethoxysilane and/or a triethoxysilane and/or a dimethoxysilane and/or a diethoxysilane.

In a further embodiment, the trimethoxysilane is selected from: allyltrimethoxysilane (CAS number: 2551-83-9); butenyltrimethoxysilane; vinyltrimethoxysilane (CAS number: 2768-02-7) or (styrylethyl)trimethoxysilane (CAS: 134000-44-5); (stilbenylethyl)trimethoxysilane; 3-(trimethoxysilyl)propyl methacrylate (CAS number: 2530-85-0); trimethoxy(4-vinylphenyl)silane (CAS number: 18001-13-3); (trimethoxysilyl)benzene (CAS number: 2996-92-1); trimethoxy(2-phenylethyl)silane (CAS number: 49539-88-0); octyltrimethoxysilane (CAS number: 3069-40-7); propyltrimethoxysilane (CAS number: 1067-25-0); (trimethoxysilyl)stilbene; or the triethoxysilane is selected from: triethoxyvinylsilane (CAS number 78-08-0), or (3-chloropropyl)triethoxysilane (CAS number: 5089-70-3); or the dimethoxysilane is selected from dimethoxydiphenylsilane (CAS number: 6843-66-9); or the diethoxysilane is selected from: diallyldiethoxysilane, methylvinyldiethoxysilane or allylmethyldiethoxysilane.

More particularly, all aromatics and alkanes containing di- and trimethoxy or di- and triethoxy groups and the unfunctionalized glass substrate are suitable for the bonding (adsorptive or chemically covalent) of the detection reagent to the substrate. The aromatics mentioned here explicitly also include stilbene (1,2-diphenylethene) and in particular the derivatives thereof that are substituted by aromatics.

In a further embodiment, a method of detecting an analyte having an NOx group is proposed, which comprises providing an analyte-sensitive layer on a silicatic substrate. This comprises a detection reagent according to any of the above-detailed embodiments covalently bonded to the silicatic substrate via at least one —Si—C— bond. Alternatively, the detection reagent according to the above-described embodiments may be adsorptively bound to the silicatic substrate, in which case the silicatic substrate does not comprise any polymer film, and the analyte-sensitive layer is provided by contacting of a silicatic substrate with a detection reagent according to one of the embodiments already mentioned. The contacting is effected here, for a detection reagent with R₁ or R₇ selected from CO₂X and PhCO₂X, under the conditions of a Heck reaction or metathesis reaction. The Heck reaction can be effected, for example, in toluene under reflux in the presence of Pd(OAc)2 and tri(o-tolyl)phosphine (CAS Nr.: 6163-58-2). Secondly, the contacting, for a detection reagent wherein R₁ or R₇ is selected from CO₂Y and PhCO₂Y, may comprise adsorbing from a solution of the detection reagent on the silicatic substrate. The outcome is that the silicatic substrate is modified with a radical of a triphenylamine compound according to the formula image below. The structures according to formula images 6.4 and 6.5 are likewise suitable for modification of the substrate.

The proposed method of detecting an analyte comprising an NOx group further comprises interaction of the analyte comprising the NOx group with the analyte-sensitive layer and measuring a fluorescence property of at least a section of the analyte-sensitive layer.

In a further embodiment, the method proposed further comprises: heating and/or evaporating a defined amount of sample that potentially contains the analyte comprising the NOₓ group; guiding a gas or gas mixture comprising the heated or evaporated defined amount of sample to the analyte-sensitive layer, such that the analyte comprising the NOₓ group can interact with the detection reagent; and ascertaining a composition and/or a concentration of the analyte comprising the NOₓ group using stored measurement data from a comparative measurement.

In a further embodiment, the method further comprises regenerating the analyte-sensitive layer by contact with an NOx-free fluid, by baking it and/or by passing a flow of steam over it.

Advantageously, the regenerated analyte-sensitive layer is available for another measurement, if appropriate for a repeat measurement.

In a further embodiment, the fluorescence property is selected from: a fluorescence quantum yield, a fluorescence lifetime; a decrease in fluorescence intensity or a fluorescence quenching; or an increase in fluorescence after a preceding fluorescence quenching.

Advantageously, the fluorescence-optical test methods cited have high sensitivity.

In a further embodiment, the measuring of the fluorescence property comprises directly detecting an electrical signal from at least one detector or forming a quotient of electrical signals that are detected at different excitation wavelengths by at least one detector.

In a further embodiment, the fluorescence property is measured with a portable, preferably handheld, measurement device, and the measurement device comprises a scanning device set up to measure the fluorescence property at at least one fixed wavelength.

Advantageously, scanning devices referred to are available on the market and are highly likely to become even more common.

In a further embodiment, the detection reagent is covalently bonded to the silicatic substrate at least via a —C—Si—O— bond, where a surface concentration of the detection reagent of the analyte-sensitive layer is selected from 50-350 μmol/cm². Alternatively, the detection reagent has been adsorbed on the silicatic substrate, where its surface concentration is between 100-750 μmol/cm².

In a further embodiment, the analyte is an explosive.

In a further embodiment, a production method for the analyte-sensitive layer on the silicatic substrate is proposed, comprising the following steps: providing the silicatic substrate and contacting the detection reagent with the silicatic substrate.

The providing of the silicatic substrate in a first embodiment may comprise: activating the silicatic substrate, comprising treating the silicatic substrate with a mixture comprising hydrogen peroxide and sulfuric acid; and silanizing the activated silicatic substrate with an organosilane.

Advantageously, after the activating of the silicatic substrate (for example a glass surface), silanol groups are available, which can react with di- or trimethoxysilanes or with di- or triethoxysilanes. This enables silanizing of the surface of the substrate. A continuous monomolecular layer of the silane is typically formed on the substrate surface. The detection reagent is then adsorbed on the silanized surface of the silicatic material. In the presence of high water vapor concentrations, the detection reagent reacts with enhanced fluorescence when the silicatic substrate has been silanized with arylsilanes or long-chain alkylsilanes.

In a further embodiment, the contacting of the detection reagent with the silicatic substrate, for the detection reagent with R₁ or R₇=CO₂X or PhCO₂X, is preceded by silanizing of the detection reagent with an organosilane that bears a double bond. The organosilane is present here in an equimolar amount or in a molar excess, such that a silanization product or a silanization reaction mixture is contacted with the silicatic material. When structures 4 and 5 have been functionalized with CO₂Z, PhCO₂Z, N(CO)Z₂, PhN(CO)Z₂ or with allyl and/or homoallyl, these structures may also be silanized.

Advantageously, the analyte-sensitive layer reacts with enhanced fluorescence in the presence of high water vapor concentrations when the silicatic substrate has been silanized with an arylsilane or a long-chain alkylsilane prior to the contacting.

In a further embodiment, the organosilane is selected from: a trimethoxysilane and/or a triethoxysilane and/or a dimethoxysilane and/or a diethoxysilane.

In particular, the trimethoxysilane is selected from: allyltrimethoxysilane (CAS number: 2551-83-9); butenyltrimethoxysilane; vinyltrimethoxysilane (CAS number: 2768-02-7) or (styrylethyl)trimethoxysilane (CAS.: 134000-44-5); 3-(trimethoxysilyl)propyl methacrylate (CAS number: 2530-85-0); trimethoxy(4-vinylphenyl)silane (CAS number: 18001-13-3); (trimethoxysilyl)benzene (CAS number: 2996-92-1); trimethoxy(2-phenyl-ethyl)silane (CAS number: 49539-88-0); octyltrimethoxysilane (CAS number: 3069-40-7); propyltrimethoxysilane (CAS number: 1067-25-0); (stilbeneethyl)trimethoxysilane; (trimethoxy)stilbene, or the triethoxysilane is selected from triethoxyvinylsilane (CAS number 78-08-0), or (3-chloropropyl)triethoxysilane (CAS number: 5089-70-3), or the dimethoxysilane is selected from dimethoxydiphenylsilane (CAS number: 6843-66-9).

All organosilanes containing di- and trimethoxy or di- and triethoxy groups and even unfunctionalized glass substrate are suitable as carrier material for the detection reagent.

In a further embodiment, the silicatic substrate provided has a flat surface. For example, it is a pane and the detection reagent is contacted with the silicatic substrate at least in parts on one side and/or in parts on both sides. Alternatively, however, it is also possible to use silicate particles, for example silicate nanoparticles, as substrate. Advantageously, it is possible to use silicate nanoparticles on a polymer substrate. Accordingly, the production method for the analyte-sensitive layer may comprise the providing of a polymer substrate with a layer of silicate nanoparticles arranged thereon. This polymer substrate with the layer of silicate nanoparticles arranged thereon is treated like a silicatic substrate.

Advantageously, in the case of a double-sided coating of the substrate, regions arranged on the reverse side cannot come into contact with the analyte in the portable instrument and hence serve as comparative surface/reference surface in assessment of the fluorescence when the portable instrument is used to contact exclusively the front side of the substrate with the analyte.

In a further embodiment, the silicatic substrate used for the production method has a curved surface at least in parts and encloses a cavity having at least one entry opening for an analyte feed and at least one exit opening for the analyte removal.

Advantageously, this facilitates contact of a fluid stream comprising the analyte with the analyte-sensitive layer.

In a further embodiment, the contacting used in the production process proposed is effected using a spin-coater, a spray-coater, a piezoelectric dosage system, a printer, a nanoplotter, an inkjet printer, or a die. The contacting can likewise be effected by dipping.

Advantageously, these application techniques permit dosed application of the detection reagent on the substrate.

In a further embodiment of the proposed production process, the silicatic substrate is selected from a silicate glass, a borosilicate glass, a quartz glass, a silicon wafer, a polycrystalline silicon, a silicate nanoparticle and a silicon-containing ceramic.

Advantages of these substrates result from the possibility firstly of coating a substrate densely covered with silanol groups with an organosilane and then adsorbing a layer of the detection reagent on the monolayer that forms. In addition, the substrate surface densely furnished with silanol groups can be utilized for covalent anchoring of the detection reagent.

In a further embodiment, an analyte-sensitive layer for an analyte comprising an NOx group is proposed, comprising the following: a silicatic substrate, and a detection reagent arranged directly, without involvement of a polymer layer, on the silicatic substrate, wherein the detection reagent is selected from a substance of one of the formulae 1 to 5:

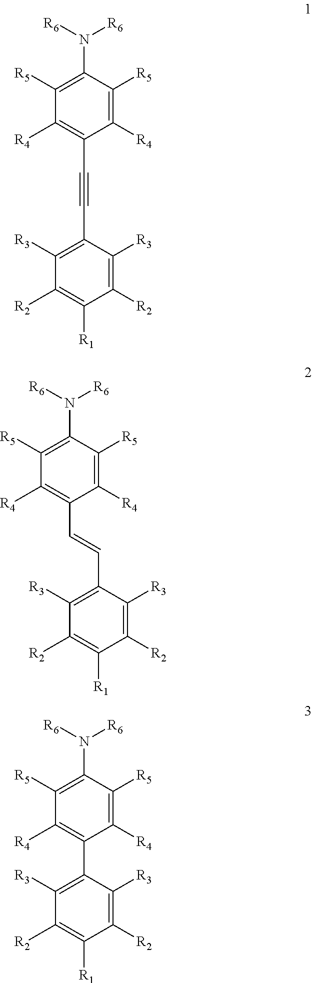

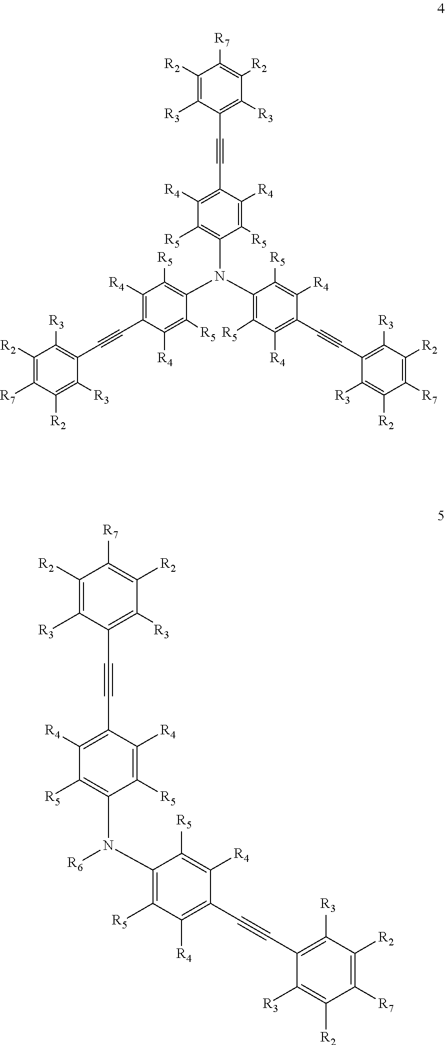

R₁ and R₇ here are selected from CO₂X or PhCO₂X with X=4-iodophenyl; 4-bromophenyl, 4-chlorophenyl, 4-vinylphenyl or 4-allylphenyl;
or R₁ and R₇ are selected from CO₂Y or PhCO₂Y with Y=2-methyl-3-pentyn-2-yl or 3-tert-butyl-4,4-dimethyl-1-pentyn-3-yl;
or R₇ is selected from CO₂Z, PhCO₂Z, C(O)NZ₂ or PhC(O)NZ₂ with Z=alkyl, perfluoroalkyl, vinyl, allyl, homoallyl, aryl.
Independently of that, R₂, R₃, R₄, and/or R₅ are independently selected from H, F, an alkyl and an aryl; and R₆ is selected from an alkyl and an aryl,
wherein the detection reagent is covalently bonded to the silicatic substrate at least via a —C—Si—C— bond, where the surface concentration of the detection reagent of the analyte-sensitive layer is selected from 50-350 μmol/cm². Alternatively, the detection reagent has been adsorbed on the silicatic substrate, where its surface concentration is between 100-750 μmol/cm². There is a change here in a fluorescence intensity of the detection reagent in the presence of the analyte with respect to a fluorescence intensity of the detection reagent in the absence of the analyte depending on a concentration of the analyte.

In a further embodiment, a layer sensitive to an analyte having an NOx group is proposed, wherein the analyte comprising the NOx group is selected from: TNT, DNT, tetryl, PETN, NG, EGDN, NH₄NO₃, RDX and HMX.

Advantageously, these analytes must be monitored as explosives in the interests of safety considerations, and so the analyte-sensitive layer described can be used in a viable manner.

In a further embodiment, the use of a detection reagent according to one of the above embodiments and/or of a method according to one of the aforementioned embodiments and/or of a production method according to one of the aforementioned embodiments and/or of an analyte-sensitive layer according to one of the aforementioned embodiments for monitoring a threshold for an explosive is proposed.

This results in the following layers that react with a change in fluorescence to the presence of NOx-containing explosives.

1. If an untreated glass substrate has been coated with a detection reagent bound by attraction, the layer of the detection reagent reacts typically with quenching of fluorescence on contact with an NOx-containing analyte.

2. If the detection is in enhanced form, in adsorptively bound form on a glass substrate silanized with an organosilane, the enhanced detection layer typically reacts with enhanced fluorescence in the presence of high water vapor concentrations to the presence of an Enno X-containing analyte when the glass substrate has been silanized with arylsilanes or long-chain alkylsilanes.

3. If, in a first step, an organosilane compound that bears a double bond (in equimolar amount or in excess) is coupled to the dye via a Heck reaction or metathesis reaction and the reaction mixture or the isolated product is reacted with the activated glass substrate or applied to the glass by means of spin-coating, the analyte-sensitive layer achieved typically likewise reacts with enhanced fluorescence in the presence of high water vapor concentrations to the presence of NOx-containing explosives when the glass substrate has been silanized with aryl-silanes or long-chain alkylsilanes.

In a first aspect, the detection reagent proposed is a dye having a base structure selected from a 4-(phenylethynyl)phenylamine, a 4-(phenylethenyl)phenylamine and/or a biphenylamine derivative and/or a diphenylamine or diphenylamine derivative. The dye usable as detection reagent for nitroaromatics, nitroalkanes, nitroamines, nitrates, nitric acid, nitrous acid, nitrogen oxides, and additionally for sulfur dioxide (which occurs in the breakdown of gunpowder), thus has a base structure of one of the following formula images 1 to 5:

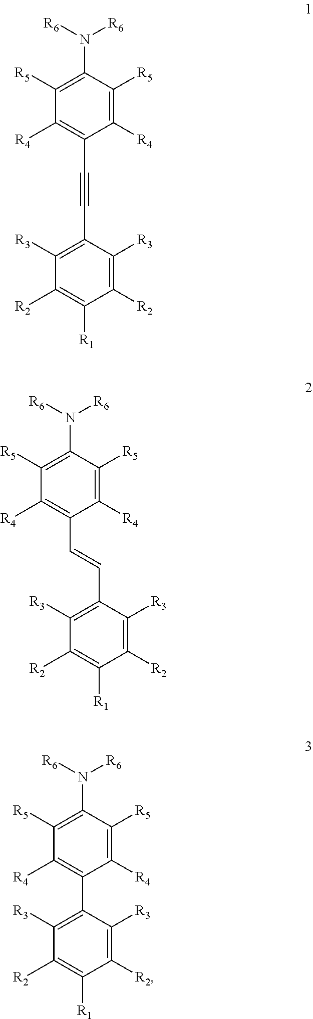

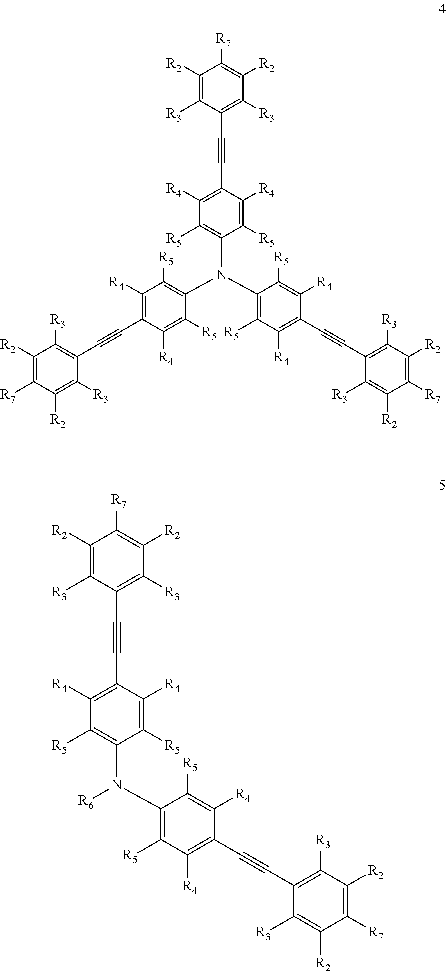

Here: R₁, R₇=CO₂X or PhCO₂X with X=4-iodophenyl; 4-bromophenyl or

4-chlorophenyl; 4-vinylphenyl; 4-allylphenyl or R₁, R₇=CO₂Y or PhCO₂Y with Y=2-methyl-3-pentyn-2-yl or 3-tert-butyl-4,4-dimethyl-l-pentyn-3-yl; or
R₇=CO₂Z, PhCO₂Z, C(O)NZ₂ or PhC(O)NZ₂ with Z=an alkyl, a perfluoroalkyl, a vinyl, an allyl, a homoallyl and an aryl. Independently thereof:
R₂, R₃, R₄ and R₅ independently=H, F, an alkyl, an aryl; and
R₆=an alkyl or an aryl.

Where the R₁ or R₇ radical can be reacted with a silane having a reactive double bond in a Heck reaction or metathesis reaction in such a way that the substituent R₁ is an ethoxysilane or a methoxysilane. Thus, the dye that serves as detection reagent may be anchored covalently to a substrate. Silicatic substrates are preferably useful here, for example a mineral glass such as borosilicate glass or a substrate endowed with a silicate layer, for example a polymer coated with silicate nanoparticles.

Alternatively, the compound 1, 2, 3, 4 or 5 may in each case be in adsorbed form on the silicatic substrate on its own or via a self-assembled monolayer (SAM) of an arylsilane, where the sterically demanding Z group prevents aggregation and associated self-quenching of fluorescence.

In preferred embodiments, R₁ and R₇ are CO₂X and PhCO₂X with (X=4-iodophenyl; 4-bromophenyl; 4-chlorophenyl; 4-vinylphenyl; 4-allylphenyl, or for CO₂Y with Y=2-methyl-3-pentyn-2-yl or 3-tert-butyl-4,4-dimethyl-1-pentyn-3-yl.

For example, it is further preferable when each of R₂-R₅ is H, especially in combination with one of the above-described preferred embodiments. It is further preferable when R₆ is a methyl or alkyl or a phenyl group or has the structures (4) and (5), especially in combination with the above-described preferred embodiments.

It is further preferable when a triaryl group is covalently bonded to the para-substituted phenyl group via a triple bond. The CO₂X or PhCO₂X substituent with X=4-iodophenyl; 4-bromophenyl, 4-chlorophenyl, 4-vinylphenyl or 4-allylphenyl enables reaction of the detection reagents with reactive organic silanes by way of a Heck reaction or metathesis reaction, such that a self-assembled monolayer of the detection reagents can be constructed on an appropriately activated substrate (cf. FIG. 2). It is further preferable when R₁, R₇=CO₂Y with Y=2-methyl-3-pentyn-2-yl or 3-tert-butyl-4,4-dimethyl-1-pentyn-3-yl. The sterically demanding 2-methyl-3-pentyn-2 -yl and 3-tert-butyl-4,4-dimethyl-1-pentyn-3-yl groups improve the solubility of the detection reagents and prevent aggregation and associated self-quenching of fluorescence.

What is proposed is more preferably detection of nitroaromatics, nitroalkanes, nitroamines, nitrates, nitric acid, nitrous acid, nitrous gases and sulfur oxide using a 4-(phenylethynyl)triphenylamine compound or (biphenylethynyl)triphenylamine dye of the formulae 6, 7 and 8 shown below—i.e. an (a)symmetric triphenylamine derivative:

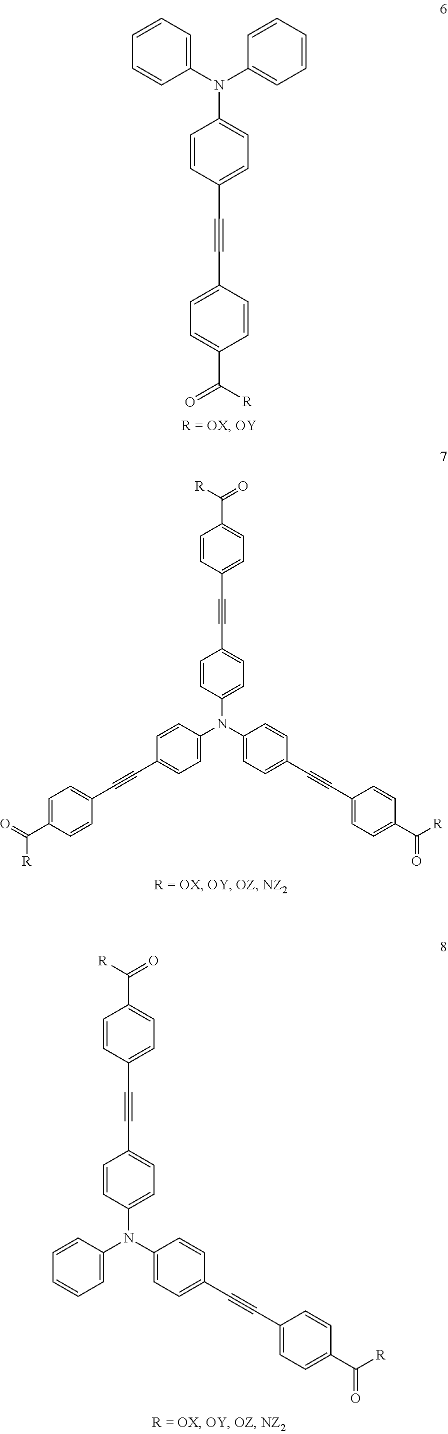

Here, X=4-iodophenyl; 4-bromophenyl, 4-chlorophenyl, 4-vinylphenyl or 4-allylphenyl; Y=2-methyl-3-pentyn-2-yl or 3-tert-butyl-4,4-dimethyl-1-pentyn-3-yl; Z=alkyl, perfluoroalkyl, vinyl, allyl, homoallyl and aryl.

One, two or three of the three phenyl groups of the triphenylamino group in these detection reagents is/are covalently bonded to a phenyl group via a triple bond. The triphenylamino group covalently bonded to a phenyl group via a triple bond in turn is preferably substituted by an electron-withdrawing group in the para position. Among the useful test methods here, colorimetry as one of the most insensitive formats is not very suitable for trace analysis. By contrast, fluorescence-based test methods are typically more sensitive at least by a factor of 1000. For this reason, preference is given here to this measurement principle.

An additional factor is that a spectroscopic measurement using a liquid phase has to rule out any disruptive influence of the solvent on the analyte. For the explosives of interest here (primarily aromatic nitro compounds), the formation of Meisenheimer complexes of the solvent (e.g. DMF, ACN) with the analyte (e.g. TNT) which themselves have strong absorption is known. Against this background, preference is further given here to a solid phase-assisted detection method. In other embodiments, it is further preferable when the detection reagent of the above formula 1 has one of the structures 6.1 to 6.5 and 4.1:

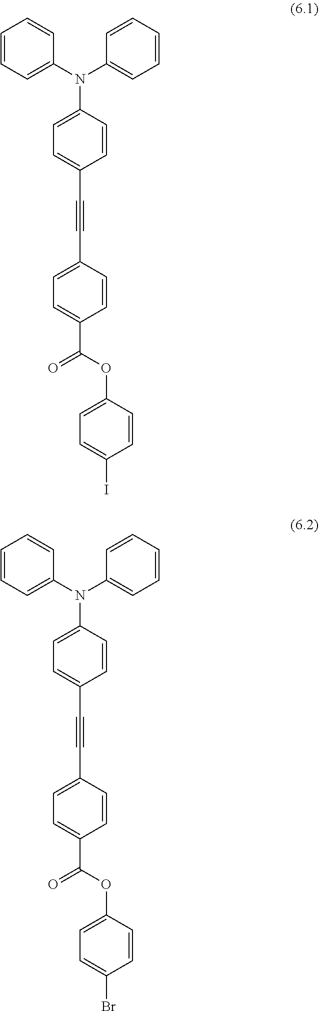 [SMILES: O=C(Oc1ccc(I)cc1)c1ccc(C#Cc2ccc(N(c3ccccc3)c3ccccc3)cc2)cc1 ; O=C(Oc1ccc(Br)cc1)c1ccc(C#Cc2ccc(N(c3ccccc3)c3ccccc3)cc2)cc1]

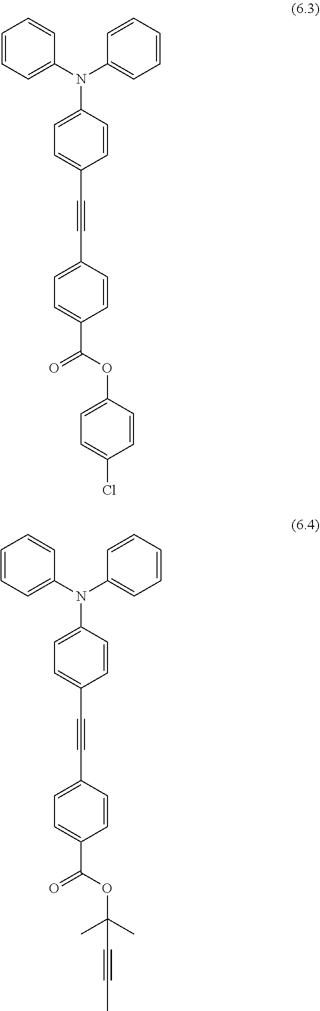 [SMILES: O=C(Oc1ccc(Cl)cc1)c1ccc(C#Cc2ccc(N(c3ccccc3)c3ccccc3)cc2)cc1 ; CC#CC(C)(C)OC(=O)c1ccc(C#Cc2ccc(N(c3ccccc3)c3ccccc3)cc2)cc1]

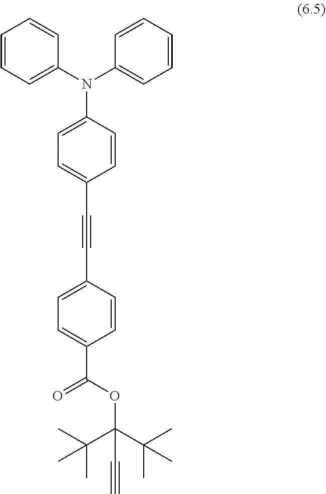 [SMILES: C#CC(OC(=O)c1ccc(C#Cc2ccc(N(c3ccccc3)c3ccccc3)cc2)cc1)(C(C)(C)C)C(C)(C)C]

As well as sensitivity toward the explosives mentioned at the outset, the electron-withdrawing group R₁ in the indicator 1 in compounds of the formula 6 also has a strong influence on the molecular mobility of the fluorescence indicator when it is at a solid/air phase boundary. It is likely that the molecules aggregate at such phase boundaries under the influence of air humidity, which acts as a mobile phase, at the surface which acts as a stationary phase, such that its fluorescence is reduced owing to self-quenching. This aggregation and the associated self-quenching can be counteracted by the sterically demanding groups shown by way of example in formula images 6.4 and 6.5. A further advantage of the introduction of the 2-methyl-3-pentyn-2-yl radicals or related structures is manifested in an improved solubility of the compounds in organic solvents. This facilitates the preparation of detection reagents directly bound adsorptively to the solid substrate, where the adsorption, by contrast with the polymer layers described in DE 10 2015 119 765.0, is effected without the involvement of a polymer cushion arranged between substrate and detection reagent. It is possible to achieve the high loading densities of the solid substrate (carrier material) that are the aim here. Typical loading densities in this embodiment are from 400 μmol/cm² to 750 μmol/cm². In the presence of steam, for example when 4-5 ul of water are evaporated fully in the thermal head of the measuring instrument within 5 sec and guided onto the sensor material, an analyte-sensitive layer comprising compound 6.4 and/or 6.5 reacts with a specific quenching of fluorescence to the presence of NOx-containing compounds. In the case of pure water, fluorescence intensity increases and then drops back to the baseline. In the case of small amounts of NOx, fluorescence increases at first and drops below the baseline. In the case of large amounts of NOx, fluorescence decreases and can thus be used in an appropriate calibration in the relevant temperature and air humidity range for detection of the explosives mentioned at the outset.

If the indicator 6.1, 6.2 or 6.3 is applied directly to a substrate suitable for measurement of fluorescence, for example to a glass surface, the intensity of measurable emission signals is not constant, but drops constantly. The cause of this seems to be self-quenching. The problem of self-quenching was solved in the case of the already known AFPs with the aid of sterically demanding iptycene units that prevent intermolecular interactions between apolar conjugated polymers on polar surfaces. Already known concepts are thus based on the use of a fluorescent (conjugated) polymer. The main cause of the quenching of the fluorescence of the dye class described here is either photo bleaching, a change in ambient polarity or local temperature effects and their influence on the matrix. A means of reducing this effect is the application of dyes such as 6.1 to 6.3 directly to glass, for example by means of spin-coating, with a concentration of the dye solution 10-fold higher than in the case of the coating of the polymer films described above in patent application DE 10 2015 119 765.0. A disadvantage of a TNT sensor comprising detection reagent adsorptively bound to glass is the it likewise reacts with quenching of fluorescence on exposure to large amounts of water vapor and does not recover completely after the decrease in signal. In this context, a “large amount of water vapor” is understood to mean a volume of 4-5 μl of water that evaporates completely in the thermal head of the measuring instrument within 5 sec and is guided onto the sensor material. Nevertheless, detection reagent bound purely adsorptively on glass enables the detection of TNT (cf. FIG. 4A).

In a second aspect, by contrast with this previously known approach, what is proposed here is stabilizing the emission signal from a fluorescent molecule, namely a compound 1 to 5, on a solid substrate. In typical practical embodiments, this is effected either adsorptively or by covalent anchoring by means of organosilicon compounds.

A layer of the detection reagent arranged on a substrate is referred to hereinafter as analyte-sensitive layer.

By contrast with the stabilization of a layer of the detection reagents on a substrate with the aid of a polymer cushion, which has been described in detail in DE 10 2015 119 765.0, what is proposed in the present case is arranging the detection reagents of the general formula images 1, 2, 3, 4 and 5 directly on the substrate. Advantageously, the substrate comprises a silicatic material and therefore, after corresponding activation in the presence of H₂SO₄ and H₂O₂ (i.e. in peroxomonosulfuric acid or in piranha solution), has silanol groups. It is likewise possible (additionally or alternatively) to activate the substrate in a low-pressure plasma. It is thus possible to form self-assembled silane-based molecular monolayers of the detection reagents on the substrate. In a first basic embodiment, these may be bound covalently to the substrate; in a second basic embodiment, the detection reagent may be adsorptively bound to a silane layer covalently anchored to the substrate. The invention thus relates, in its broadest sense, to fluorescent silane layers for detection of explosives comprising NOx.

For the detection of one or more nonvolatile explosives and/or optionally of one or more of the compounds used as markers for explosives or of another NOx-containing analyte, what is proposed is determining the progression of quenching of fluorescence of the detection reagent with time. The presence of the explosives and hence the existence of an endangerment potential is thus detected with reference to quenching of a fluorescence signal synchronously with a reversible (physicochemical) interaction of the explosives (markers) with the detection reagent and/or with reference to an increase in fluorescence after prior quenching of the fluorescence of the detection reagent (i.e. during a regeneration). In terms of measurement technology, for this purpose, a progression of a fluorescence intensity with time is detected in a specific wavelength range. Regeneration of fluorescence on desorption of the explosive from the analyte-sensitive layer is likewise detectable in terms of measurement technology. These regeneration kinetics correlate with the vapor pressure of the explosive and can additionally be employed for identification and possibly quantification.

The NOx-containing analyte (explosive, marker, pesticide) may be present in the air, on the surface of an article (article surface), in aqueous or organic liquid, or in the extract of a sample, for example a soil sample. Thermally induced sublimation, for example after the breakdown of the analyte to give nitrogen oxides, can also serve for specific detection in accordance with the method. The exceedance of a critical concentration (limit) of the analyte in/on a sample indicates endangerment in accordance with the method. For the finding of endangerment, the qualitative detection of the NOx analyte on its own is also utilizable in accordance with the method.

The sample can be transferred from an article surface to the analyte-sensitive layer either directly by flow (transfer) via explosive and/or marker vapors released from the surface, or can first be detected from the surface and applied to the analyte-sensitive layer with the aid of a transfer article. The latter principle is known as the wiped sample method.

Advantages of the detection of NOx compound, such as TNT in the air, in water, in organic solvents and on surfaces, are obvious. Advantages of the detection method proposed and of the detection reagents utilized here relate to uncomplicated sample processing that permits direct and rapid detection of an endangerment potential directly on site.

Further advantages are apparent from the simplicity achieved in the application and the minor influence of environmental effects on the measurement. The advantages of the analyte-sensitive layers described here are obvious: exact measurements can be executed in a fault-free manner even by untrained users with the appropriate measuring instrument. The layers are producible reproducibly in a large number, are stable under air and can be stored for an indeterminate period under protective gas. The minor effect of water and organic solvents, in association with the appropriate measuring instrument, assures reliable measurement of air, samples in water and wiped samples in a wide variety of different measurement situations.

In a further aspect, a method of detecting an NOx compound is proposed, wherein the detection is effected with a portable, preferably handheld, reading device that includes a scanning device that measures at at least one defined wavelength.

Advantageously, suitable reading devices are commercially available and are already used for various tests for detection of chemicals of environmental relevance. Constant further development of such portable devices can be expected, and so firstly, if appropriate, the sensitivity of the implementable test methods, but secondly also the range of reproducibly and reliably evaluable spectroscopic parameters should be extended in the future.

Accordingly, a method of detecting an NOx compound in the air is proposed, wherein the method comprises:
providing an analyte-sensitive fluorescent layer comprising a substrate with one of the above-described fluorescence probes;
measuring fluorescence in real time and detecting a fluorescence property, especially a decrease in fluorescence of the analyte-sensitive layer on interaction of the analyte with the analyte-sensitive layer.

The process may optionally further comprise at least one of the following steps:
guiding a gas stream (e.g. air stream) potentially contaminated with a nitro compound onto the fluorescent layer, such that the section of the carrier material loaded with the fluorescence probe is fully wetted by the air flow;
qualitatively analyzing the NOx compound with reference to comparative values and/or curve progressions and/or at least one previously detected regeneration phase on contact of the analyte-sensitive layer with a flow of analyte-free air or of analyte-free water vapor;
ascertaining a concentration or a concentration range of the analyte (e.g. explosive) in the gas flow with reference to a comparative value and/or a calibration curve, where the comparative value and/or the calibration curve have been ascertained after interaction of the fluorescence probe with a known concentration of the analyte, for example in air.

The measurement of fluorescence quenching described can be effected, for example, from the reverse side of the substrate (i.e. from the uncoated side of the substrate). A corresponding measurement arrangement requires an optically transparent substrate material. It is likewise possible to measure from the coated side. The substrate (carrier material) thus need not be transparent. If a suitable transparent substrate is used, for example glass, owing to the optical fiber properties of such a substrate, given reproducible coupling of the fluorescence light into the substrate, the fluorescence can also be measured from an outer edge of the substrate. This results, for example, in an advantageously compact measurement arrangement.

In accordance with the method customary in residue analysis, after calibration of the measurement signal for the concentration range in question with a currently determined measurement value (fluorescence quenching), it is possible to use the ratios of the sample volume used (aliquot) to deduce the original concentration of the analyte in question in the respective original sample (matrix+analyte).

A method of detection of an NOx compound (explosive) from a solution, especially from an aqueous or organic solution, is accordingly proposed, wherein the method comprises:
providing an analyte-sensitive layer comprising a substrate with one of the above-described fluorescence probes;
measuring a decrease in fluorescence and/or regeneration characteristics of the fluorescence of the analyte-sensitive layer in real time on interaction with the analyte with a suitable measurement arrangement. The method may optionally further comprise at least one of the following steps:
evaporating the solution potentially contaminated with the analyte to be detected at a heated air inlet and guiding the resultant vapors with an air stream to the fluorescent analyte-sensitive layer, such that at least a section of the analyte-sensitive layer is completely wetted by the air flow;
qualitatively analyzing the NOx compound with reference to comparative values and/or curve progressions and regeneration phases;
ascertaining a concentration or a concentration range of the analyte (explosive) in the solution with reference to a comparative value and/or a calibration curve, where the comparative value and/or the calibration curve have been ascertained after interaction of the fluorescence probe with a known concentration of the analyte.

In a further embodiment, a method of detecting an NOx compound, especially a nitroaromatic explosive, on a surface is proposed. The method comprises the steps of:
loading a substrate with one of the above-described fluorescence probes and obtaining a fluorescent analyte-sensitive layer (indicator layer). This indicator layer is advantageously disposed on a rigid substrate and is resistant to a fluid flow (especially of a heated gas);
detecting a progression of a fluorescence signal in at least one section of the indicator layer with time on interaction of the analyte with the analyte-sensitive layer, especially a decrease in a fluorescence of the indicator layer. As also above, the fluorescence can be measured either in transmission mode or as an epifluorescence measurement. The method may optionally further include at least one of the following steps:
Absorbing analysis material from a surface with a wiped sample material, such that analysis material present on the surface is transferred to the wiped sample material.
Heating the wiped sample material to a temperature of >150° C. Guiding thermal sublimation and/or breakdown products of the wiped sample material that have been released here with a carrier gas stream (e.g. with a noble gas, a dry gas, or air) onto the fluorescent indicator layer. In so doing, the section of the substrate loaded with the detection reagent is fully wetted by the carrier gas flow. As a result, the analytes introduced in the carrier gas stream can interact with the fluorescence probe.
Qualitatively analyzing the NOx compound with reference to comparative values and/or curve progressions that have been previously recorded or are stored in a database. It is likewise possible to employ a regeneration phase, i.e. a recovery of an initially at least partly quenched fluorescence under the action of a pure carrier gas (e.g. air) or with water vapor for assessment of the physical nature and/or concentration of the analyte in the carrier gas stream.
Ascertaining a concentration or a concentration range of the analyte (explosive) on the sample carrier with reference to a comparative value and/or a calibration curve, where the comparative value and/or the calibration curve has been ascertained after interaction of the fluorescence probe with a known concentration of the NOx-containing analyte, for example the explosive or a marker substance of explosives.

Irrespective of the nature of the respective sample and the respective analyte-sensitive layer, measurement of fluorescence may comprise synchronous excitation of one or more analyte-sensitive layers at different excitation wavelengths and/or at different emission wavelengths. For excitation it is possible to use one or more light sources, for example laser, LED, OLED, incandescent lamp.

The use of fluorescent conjugated polymers for detection of explosives by means of quenching a fluorescence is known, for example, from U.S. Pat. Nos. 8,287,811 B1; 8,323,576 B2; 8,557,595 B2; 8,557,596 B2; CN 101787112 and [3 -5]. The multitude of known detection methods for explosives based on NOx is based on the specific interaction between the AFP and the analyte with a high oxidation potential. In order to achieve a high-sensitivity, thin layers of the AFPs are applied directly to the substrate used, for example to a glass.

The disadvantages of known detection methods based on conjugated polymers (AFPs) for detection of explosives can be summarized as bullet points as follows:
The existing cross-sensitivities of the fluorescent sensor materials that are currently considered to be at the technological forefront can lead to false alarms, for example including as a result of abrupt changes in air humidity or as a result of interaction with substances having a high oxidation potential that are not among the explosives or markers. The cross-sensitivities that exist impair the overall efficacy or market acceptance of the sensor materials.
This in turn has the disadvantage that the sensitivity for the particular explosive decreases. Therefore, the field of use of such AFPs as sensors for explosives based on NOx is limited to relatively constant weather and environmental conditions.
As well as elevated air humidity and water, it is also possible to use water-miscible organic polar solvents, and substances that produce water vapor thermally, such as salts containing water of crystallization, or thermally induced condensation reactions to increase the cross-sensitivity of the respective sensor material, or lower the specific sensitivity for the analyte.
In order to achieve high sensitivity toward the explosives, monomolecular layers of the conjugated polymers are required.
The signal formation is based solely on the interaction between the conjugated polymer and the analyte. The carrier material used, for example glass, shows only a weak interaction with volatile analytes.
The DMDNB marker, the presence of which has been obligatory in commercially available explosives since 1991, can be detected only in a few cases with the aid of AFPs [7].

Detailed description of the synthesis of used detection reagents

The detection reagents 6 are synthesized as shown in schematic form in FIG. 1. All reagents come from commercial manufacturers and were used without further purification. All air- and moisture-sensitive reactions were conducted under protective gas (argon) in dry glass apparatuses. Triethylamine (TEA), toluene (tol.) and tetrahydrofuran (THF) were dried over molecular sieve (4 Å). Fluorescence measurements in solution and on surfaces were detected with a FluoroMax-4P spectrofluorometer (Horiba Jobin-Yvon, Bensheim).

### Activation and Functionalization of the Glass Substrate Surface

The glass substrates were heated up to 98° C. in piranha acid (40 mL of H₂O₂ (30%) and 60 mL of H₂SO₄) for 2 h. After washing with deionized water, the glass substrates were washed with acetone in a Soxhlet apparatus for 3 h. After drying (1 h at 150° C.), the glass substrates (if silicate nanoparticles are used, the activation can be dispensed with) were heated in toluene (3 mL) with a silane derivative (0.4 mM), triethylamine (50 μL) and the free-radical inhibitor BHT (50 mg) (in order to prevent polymerizations, if double bonds are present in the silane derivative) to 110° C. for 18 h. The silanized glasses were then washed with ethyl acetate in the Soxhlet apparatus for 3 h, dried under air for 1 h, coated with the detection reagent and then stored with exclusion of light and under protective gas.

The high photostability of the detection reagent 6.5 on hydrophobic surfaces is augmented by the high quantum yields of this molecular probe.

It is similarly advantageous that the main absorption and fluorescence bands of the triphenylaminoalkynes described are within the visible spectral range. For this reason, it is possible to dispense with UV excitation of the probe to generate a fluorescence signal. This gives rise to reduced costs and the possibility of implementation of a portable measuring device since UV excitation sources (at least nowadays) are much more expensive, less stable and usually also of greater dimensions than, for example, reading devices equipped with LEDs.

### BRIEF DESCRIPTION OF THE DRAWINGS

The appended figures illustrate embodiments and, together with the description, serve to elucidate the principles of the invention. The elements of the drawings are relative to one another and not necessarily to scale. Identical reference numerals denote correspondingly similar parts.

FIG. 1 shows a synthesis scheme for synthesis of the fluorescence probes;

FIG. 2 shows reaction of a detection reagent of formula 6.1 by means of a Heck reaction;

FIG. 3 shows a fluorescent signal progression of detection reagent of structure 6.5;

FIGS. 4, 4A and 4B show fluorescence signal progression of dye on glass;

FIGS. 5, 5A and 5B show fluorescence signal progression of dye on a coated glass substrate;

FIGS. 6, and 6A-6D show fluorescence signal progression of dye under different conditions;

FIG. 7 shows fluorescence spectra of dye on differently coated glass substrates; and

FIG. 8 shows different examples of adsorptive binding of different fluorescent probes to the glass substrates.

### DETAILED DESCRIPTION

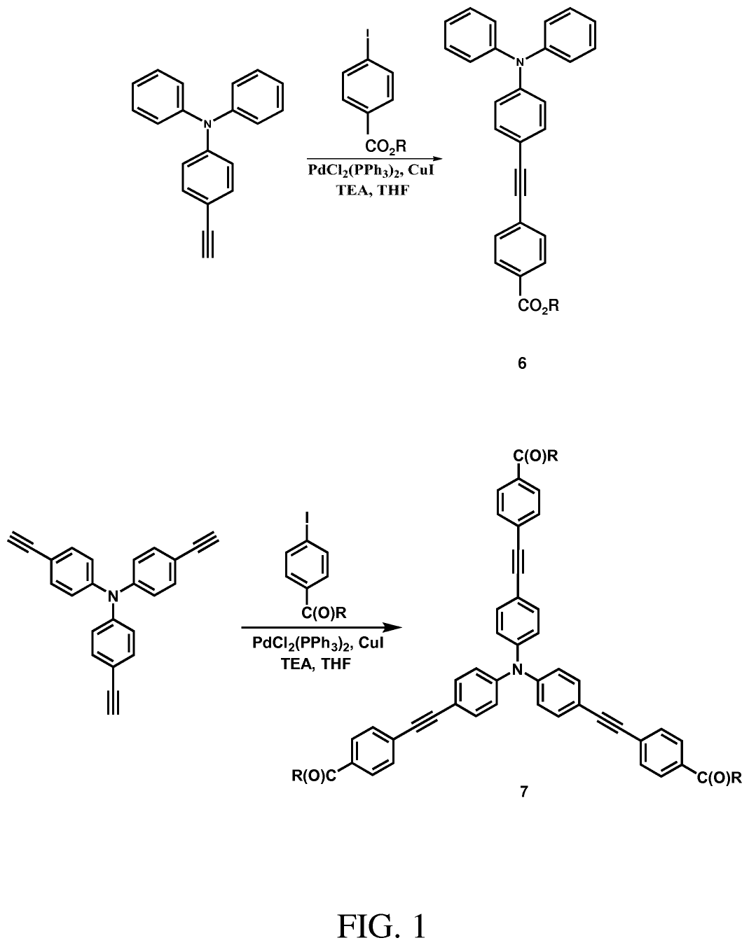

FIG. 1 shows a synthesis scheme for synthesis of the fluorescence probes 6 and 7.

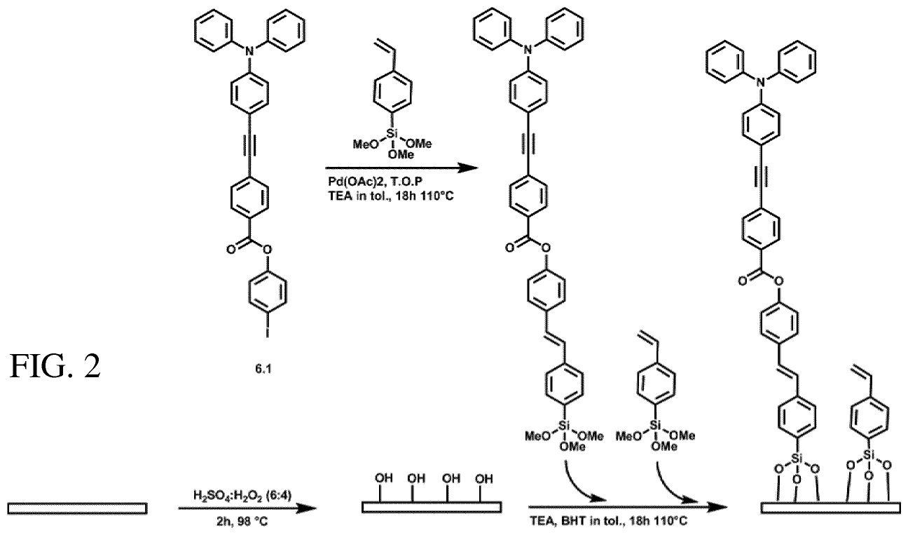

FIG. 2 shows, by way of example, the reaction of the detection reagent of formula 6.1 with trimethoxy(4-vinylphenyl)silane by means of a Heck reaction. The organosilanes can also be used here in excess. The silane dye formed or the reaction mixture can be reacted directly with the surface of the substrate.

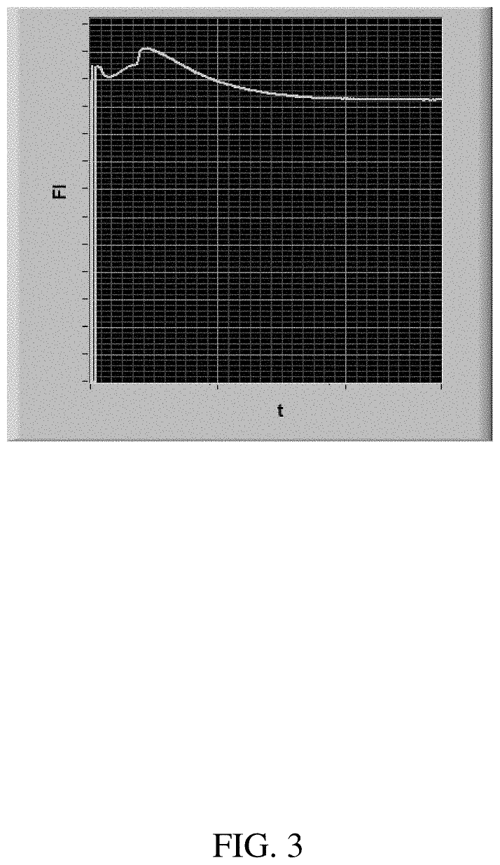

FIG. 3 shows the fluorescence signal progression of the detection reagent of structure 6.5 adsorbed directly on glass (with no polymer cushion or organosilane layer) after sustained operation for 30 min. The measurement was conducted in a portable measuring instrument at a thermal head temperature of 155° C., with minimal light intensity of the excitation source and in an air stream.

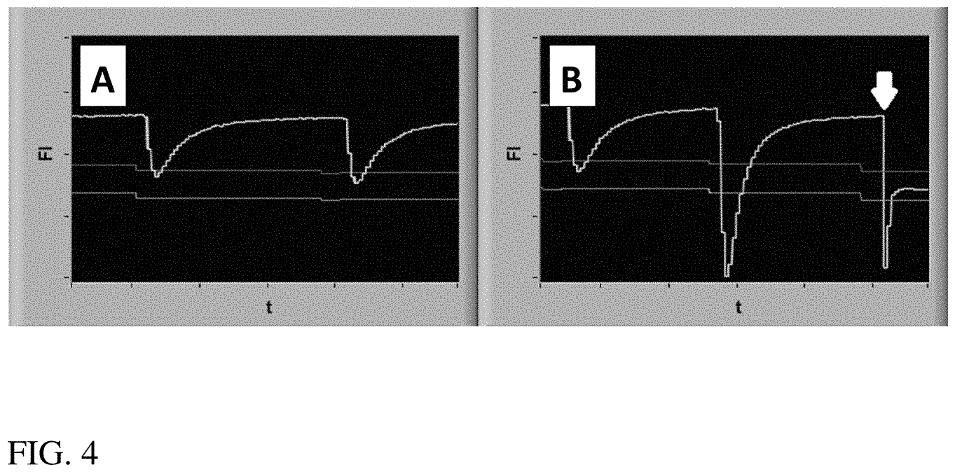

FIG. 4; FIG. 4A shows the fluorescence signal progression of the dye 6.5 on glass; after sustained operation for 30 min, two TNT wiped samples each with 1.9 ng of TNT were detected. FIG. 4B shows a fluorescence signal progression of the dye 6.5 on glass; after sustained operation for 30 min, 4 μL of water were evaporated in the thermal head (155° C.) and gave a corresponding signal. All measurements were conducted at a thermal head temperature of 155° C., with minimal light intensity of the excitation source and in an air stream; red=detection limit for 10% fluorescence quenching; blue=detection limit for 15% fluorescence quenching.

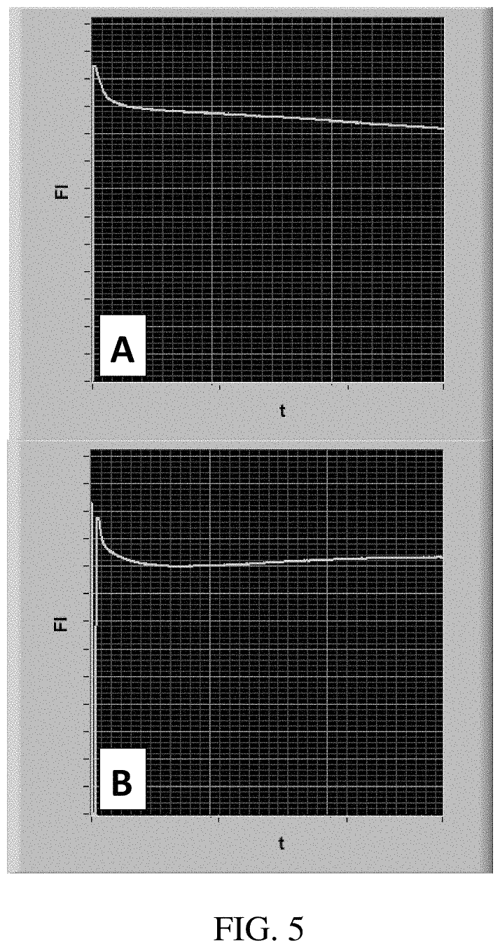

FIG. 5; FIG. 5A shows the fluorescence signal progression of the dye 6.5 on a glass substrate coated with (styrylethyl)trimethoxysilane after sustained operation for 30 min.

FIG. 5B shows the fluorescence signal progression of the dye 6.5 on a glass substrate coated with dimethoxydiphenylsilane after sustained operation for 30 min. The measurements were conducted in a portable measuring instrument at a thermal head temperature of 155° C., with minimal light intensity of the excitation source and in an air stream.

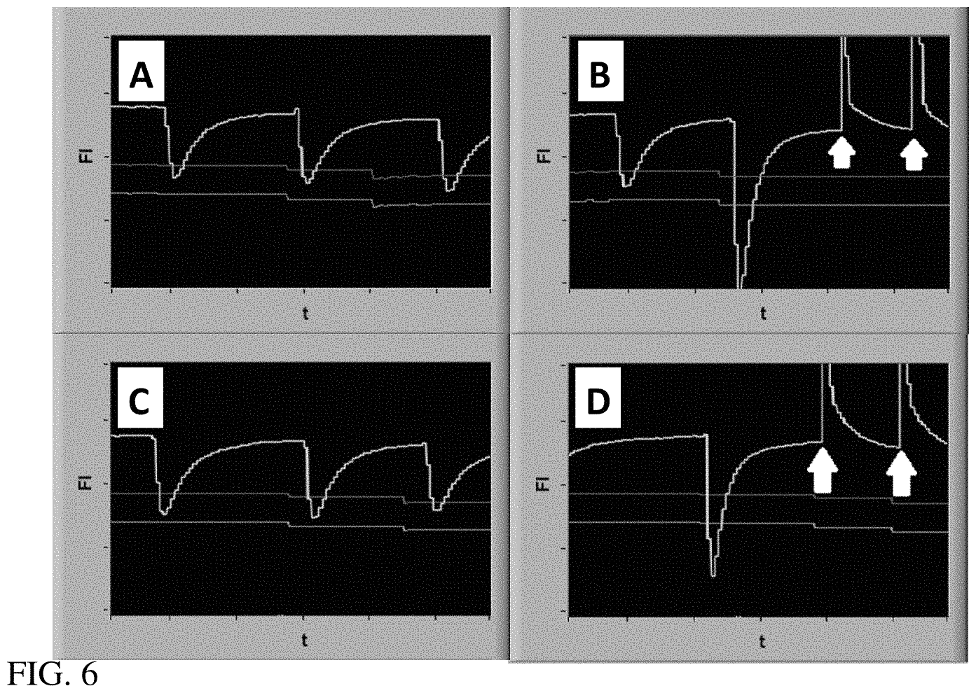

FIG. 6; FIG. 6A shows the fluorescence signal profile of the dye 6.5 on a glass substrate coated with (styrylethyl)trimethoxysilane; after sustained operation for 30 min, three TNT wiped samples each with 1.9 ng of TNT were detected. FIG. 6B shows the fluorescence signal progression of the dye 6.5 on a glass substrate coated with (styrylethyl)trimethoxy-silane; after sustained operation for 30 min, 2× 4 μL of water were evaporated in the thermal head (155° C.) and gave the corresponding signals. FIG. 6C shows the fluorescence signal progression of the dye 6.5 on a glass substrate coated with dimethoxydiphenylsilane; after sustained operation for 30 min, three TNT wiped samples each with 1.9 ng of TNT were detected. FIG. 6D shows the fluorescence signal progression of the dye 6.5 on a glass substrate coated with dimethoxydiphenylsilane; after sustained operation for 30 min, 2× 4 μL of water were evaporated in the thermal head (155° C.) and gave the corresponding signals. The measurements were effected at a thermal head temperature of 155° C., with minimal light intensity of the excitation source and in an air stream; red=detection limit for 10% fluorescence quenching; blue=detection limit for 15% fluorescence quenching.

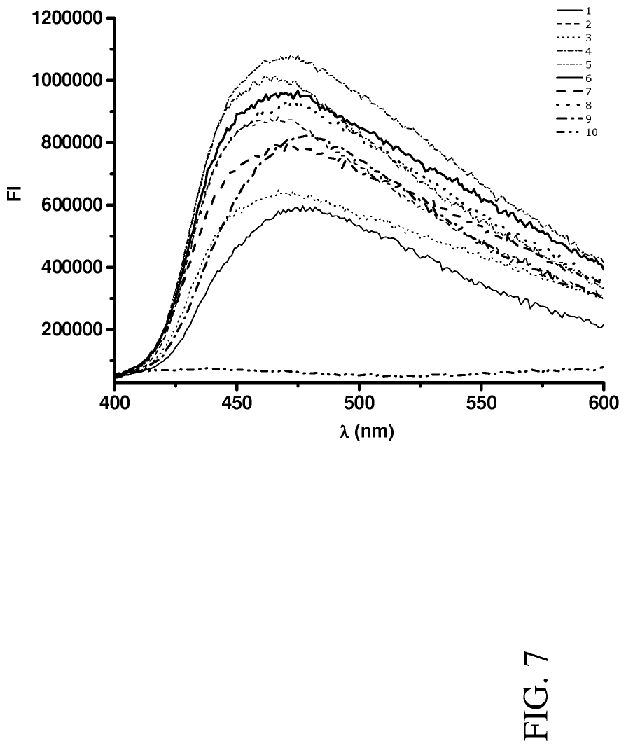

FIG. 7 shows fluorescence spectra of the dye 6.5 on differently coated glass substrates. The numbers in the legend represent:
1=activated glass;
2=3-(trimethoxysilyl)propyl methacrylate;
3=trimethoxy(4-vinylphenyl)silane;
4=dimethoxydiphenylsilane;
5=trimethoxy(2-phenylethyl)silane;
6=(styrylethyl)trimethoxysilane;
7=octyltrimethoxysilane;
8=propyltrimethoxysilane;
9=(3-chloropropyl)trimethoxysilane;
10=baseline;
   Measurement Parameters=exc. 370 nm; slit 1.5 nm; em. 380-600 nm; slit 5 nm

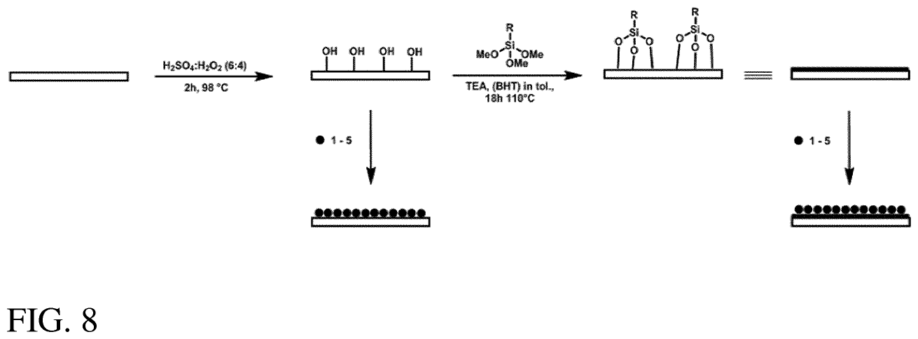

FIG. 8 shows, by way of example, the adsorptive binding of the fluorescence probes 1-5 to the glass substrates (with or without organosilane layer).

### Detailed Description of the Test Method

A first variant of the detection method proposed is based on the providing of a detection reagent in adsorbed form on a solid phase. The substrate has been coated with a fluorescent molecular probe that serves, under the measurement conditions, as a specific detection reagent for NOₓ explosives and markers of practical relevance (for example for TNT and DMDNB). The fluorescence probe comprises a triphenylamine core and an electron-withdrawing phenyl unit joined covalently to the core in the para position via a triple bond. A fluorescence probe in this connection is understood to mean a molecule that indicates the presence of an explosive via specific fluorescence properties, i.e. in the present context a triphenylamine derivative of the above-specified structures.

In this connection, a receptor unit is understood to mean a motif that interacts specifically with the NOₓ explosive to be detected, comprising a phenylamino derivative that can interact with the electron-deficient NOₓ explosive through through its high electron density. The receptor unit comprising the phenylamino group is selected such that, after optical excitation, it favors an electron transfer to the acceptor and can stabilize the radical cation formed. The two unsubstituted phenyl radicals of the phenylamino group, in steric terms, permit a rapid interaction with the explosive and at the same time increase the fluorescence quantum yield of the molecular probe.

The receptor unit of the molecular probe is also adapted such that it firstly releases an electron to the explosive as a donor and secondly accepts it again depending on the volatility of the explosive or its residence time on the sensor surface. Thus, the binding of the explosive to the receptor unit that has taken place is detected with high sensitivity with reference to a change in characteristics with respect to fluorescence optics, especially fluorescence spectroscopy, of the fluorescence probe, with typically no significant change in the position of the absorption maximum of the fluorescence probe present in bound form in said section for radiative excitation. This facilitates the readout of the measurements with a typically inexpensive and robust portable reading device (“handheld device”) that works at a fixed excitation wavelength (for example an LED).

Preferably, an amount of the NOₓ compound bound by the probe per unit time (at a given temperature) corresponds to a defined concentration of the explosive in air or as a water sample or wiped sample with an initially as yet unknown concentration of the explosive in a defined mass of sample with an initially as yet unknown content of the explosive. Naturally, the temperature has a certain effect on the establishment of equilibrium at the molecular level. By means of a suitable calibration, it is possible to match any disruptive effects, such as the temperature-dependent regeneration of the sensor layers, to the measurement conditions. Thus, the fluorescence probes are usable without difficulty for the proposed detection of explosives within a temperature range of 0-130° C.

Accordingly, a detection method for quantitative and qualitative detection of these explosives in the air, as wiped samples from surfaces and in water samples is proposed. It is a particular feature of the detection method that it is performable in a problem-free manner even by users with no specific training and it is possible to dispense with costly laboratory-based measurement technology.

For the application of the probes to the surface of the substrate, it is possible to utilize various methods. For example, the corresponding amounts of the dissolved substances can be applied to the substrate in a suitable solvent mixture with a spin-coater, spray-coater, piezoelectric dosage system, a nanoplotter or an adapted inkjet printer. Commercial single-droplet dosage systems likewise give reproducible results. Analogously, the dyes can also be applied by a suitable die techniques or contact printing methods.

In practical embodiments, cover slips typically used in microscopy are used as inert substrate. For example, it is possible to use commercial round cover slips having a diameter of 3-20 mm. The surface of the substrate is preferably planar. However, the substrate may have a curved surface at least in sections and may include a cavity having at least one inlet opening for an analyte feed and at least one exit opening for the analyte removal. Advantageously, an analyte-sensitive layer is formed on the inner surface, or a cavity section. It is likewise possible to arrange sections of different analyte-sensitive layers adjacent to one another, such that the substrate is divided into multiple zones. In a further embodiment, an otherwise homogeneous analyte-sensitive layer on the substrate (planar or interior cavity surface) can be divided into multiple zones by applying different detection reagents adjacent to one another on the substrate. For instance, sensitive layers having different properties are formed on a one-piece substrate. The arrangement thereof can advantageously be chosen such that the medium to be analyzed (analytes, or air, which only possibly contains the analyte . . . ), by virtue of geometric arrangement, flows over or through these zones in a particular sequence and/or at a particular flow rate and/or at a particular pressure. Advantageously, it is thus possible to vary the residence time of the analyte within wide limits in order to assure reliable detection.

In order to examine the selectivity of the layers for TNT, DNT, tetryl, PETN, NG, EGDN, RDX, HMX, NH₄NO₃ and DMDNB, a mobile measuring device (referred to here as “handheld device”) was used to conduct measurements of the solutions of the explosives and of some structurally related musk compounds. In the study of cross-sensitivity for musk ambrette, which is not among the explosives or markers, but shows interactions comparable with TNT with the analyte-sensitive layers, much lower sensitivity and distinguishable signal structures were observed.

It is known that molecular probes on their own cannot distinguish between the explosives sought and substances that likewise have fluorescence-quenching properties. However, the probability of finding such substances in the environment is typically very low. Exceptions are the numerous musk compounds which can occur in groundwater as constituents of various perfumes, cosmetic products and plant protection products. It is of course possible to conduct measurements on a sample with at least two analyte-sensitive layers in order to be able to come to a more exact conclusion as to the composition of the sample.

To verify the explosives in the air or as a wiped sample, the analyte-sensitive layer is contacted with a heated air stream in the measuring instrument, keeping the (heated) air inlet on the sample or on a wiped sample. For this purpose, for example, a suitable measurement head comprising the air inlet can be heated to a temperature >150° C. On attainment of the detection limit within a particular period under known environmental influences (air humidity and temperature), the presence of an NOₓ compound is indicated as quenching of fluorescence of the analyte-sensitive layer.

The triarylamine-based fluorescence indicators (detection reagents) described, with their high quantum yield, broadband excitability, high photostability, air stability and long-term stability and marked insensitivity to environmental influences (such as changes in air humidity, the presence of organic and/or aqueous solvent vapors and oxygen), are suitable for detection of explosives based on Noₓ units, for detection of thermal breakdown products of explosives such as nitrogen oxides, starting materials for production of explosives such as nitric acid and for detection of markers such as DMDNB and DNT on the corresponding carrier materials including non-fluorescent, apolar polymer films.

The triphenylamine motif of the detection reagents 6.1 to 6.5 is used for the detection of nitro compounds. After calibration, the quenching of the fluorescence signal of the analyte-sensitive layer under the influence of the explosive bound to the receptor unit serves for quantitative determination thereof in air, in aqueous and organic solution and on wiped samples. It is likewise possible to use the regeneration of the fluorescence signal of the analyte-sensitive layer that occurs under the action of water vapor, for example, to identify a previously adsorbed fluorescence-quenching analyte on its own or as a supplementary method if an unknown NOx-containing analyte is to be determined.

In a second variant of the detection method proposed here, the above-described detection reagent modified with an organosilane is covalently bonded directly to the glass substrate. In this second variant too, the glass substrate does not have a polymer film. In addition, the glass substrate may have been hydrophobized with an organosilane, for example with (styrylethyl)trimethoxysilane. The silane forms a monomolecular carrier layer on the glass substrate.

The fluorescence probe comprises the triphenylamine core already described and the electron-withdrawing phenyl unit covalently bonded to the core in the para position via a triple bond, having the properties already described above for the first variant.

The embodiments described can be combined with one another as desired. Even though specific embodiments have been presented and described herein, it is within the scope of the present invention to suitably modify the embodiments detailed without departing from the scope of protection of the present invention. The claims that follow constitute a first, non-binding attempt to define the invention in general terms.

### REFERENCES

[1] Xu F., Peng L., Orita A., Otera J. (2012) Dihalo-Substituted Dibenzopentalenes: Their Practical Synthesis and Transformation to Dibenzopentalene Derivatives. Org. Lett. 14, 3970-3973;
[2] Schröder N., Wencel-Delord J., Glorius F. (2012) High-Yielding, Versatile, and Practical [Rh(III)Cp*]-Catalyzed Ortho Bromination and Iodination of Arenes. J. Am. Chem. Soc. 134, 8298-8301;
[3] Yang Y-S., Swager T. M. (1998) Fluorescent Porous Polymer Films as TNT Chemosensors: Electronic and Structural Effects. J. Am. Chem. Soc. 120, 11864-11873;
[4] Yang Y-S., Swager T. M. (1998) Porous Shape Persistent Fluorescent Polymer Films: An Approach to TNT Sensory Materials, J. Am. Chem. Soc. 120, 5321-5322;
[5] Sanchez J. C., Trogler W. C. J. (2008) Efficient Blue-emitting Silafluorene-fluorene-conjugated Copolymers: Selective Turn-off/Turn-on Detection of Explosives. Mater. Chem., 18, 3143-3156;
[6] Che Y., Gross D. E., Huang H., Yang D., Yang X., Discekici E., Xue Z., Zhao H., Moore J. S., Zang L., (2012) Diffusion-Controlled Detection of Trinitrotoluene: Interior Nanoporous Structure and Low Highest Occupied Molecular Orbital Level of Building Blocks Enhance Selectivity and Sensitivity. J. Am. Chem. Soc. 134, 4978-4982;
[7] Thomas III, S. W.; Amara J. P., Bjork R. E., Swager T. M. (2005) Amplifying Fluorescent Polymer Sensors for the Explosives Taggant 2,3-Dimethyl-2,3-dinitrobutane (DMNB). Chem. Commun., 4572-4574;
[8] Mardelli M., Olmsted J. (1977) calorimetric Determination of the 9,10-Diphenyl-Anthracene Fluorescence Quantum Yield. Journal of Photochemistry, 7, 277-285;

1. Detection reagent for an analyte comprising an NOₓ group, wherein the detection reagent comprises an arylamine, and a structural formula of the arylamine is selected from the structural formulae 1, 2 and 3: 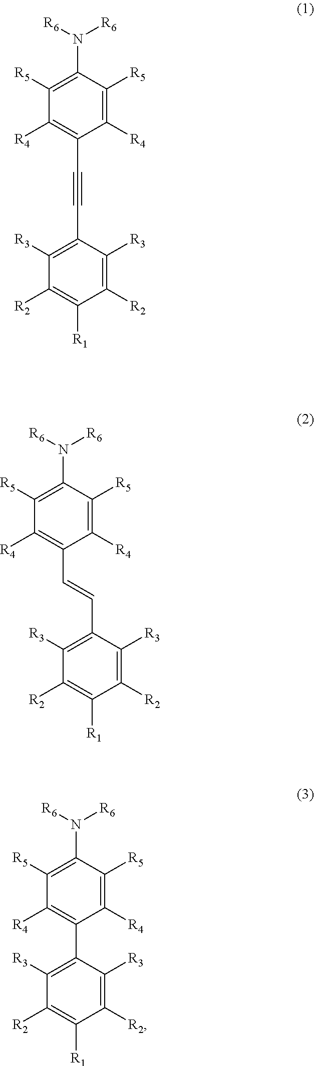
or of the formulae 4 and 5: 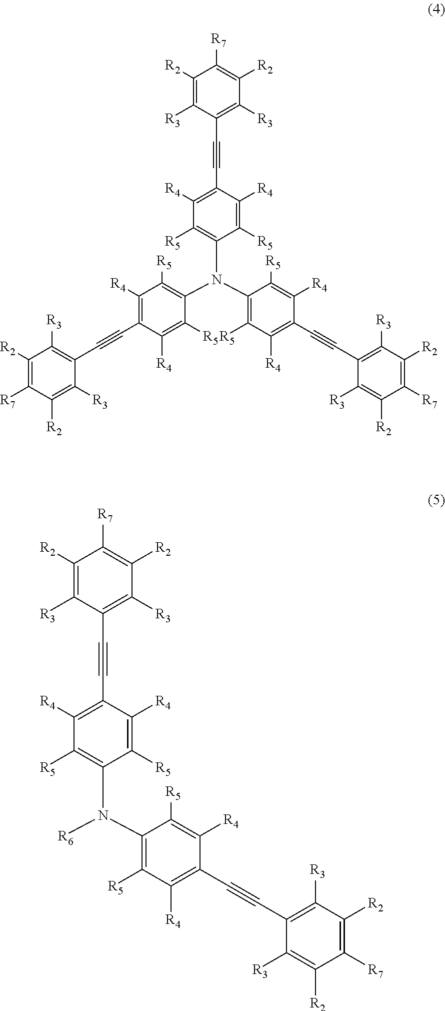
where
R₁ and R₇ are selected from CO₂X and PhCO₂X with X=4-iodophenyl; 4-bromophenyl, 4-chlorophenyl, 4-vinylphenyl or 4-allylphenyl; or
R₁ and R₇ are selected from CO₂Y and PhCO₂Y with Y=2-methyl-3-pentyn-2-yl or 3-tert-butyl-4,4-dimethyl-1-pentyn-3-yl; or
R₇ is selected from CO₂Z, PhCO₂Z,C(O)NZ₂ and PhC(O)NZ₂ with Z=alkyl, perfluoroalkyl, vinyl, allyl, homoallyl, aryl;
where
R₂, R₃, R₄ and R₅ are independently selected from: H, F, alkyl, aryl; and
R₆ is selected from alkyl or aryl.

2. original) Detection reagent according to claim 1, wherein R₂, R₃, R₄ and R₅ are H.

3. Detection reagent according to claim 1, wherein R₆ is a phenyl group and the arylamine thus comprises a triphenylamine motif.

4. Detection reagent according to claim 3, wherein the triphenylamine motif is joined covalently to a phenyl group in at least one para position, and the remaining para positions are unsubstituted or methylated.

5. Detection reagent according to claim 4, wherein the triphenylamine motif and the phenyl group are joined via a triple bond, via a double bond or via a single bond.

6. Detection reagent according to claim 3, wherein the structural formula of the arylamine is selected from a triphenylamine compound of the structural formulae 6.1 to 6.5 or 4.1: 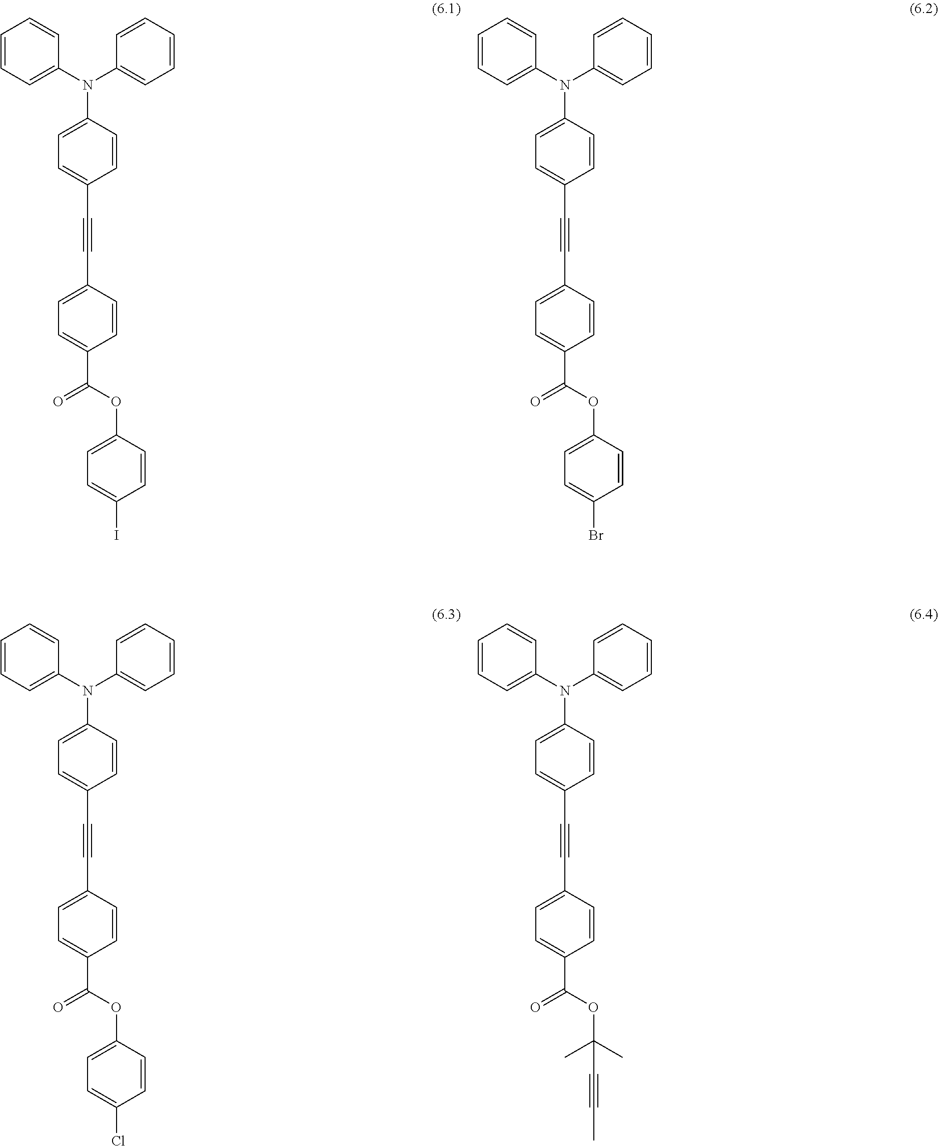 [SMILES: O=C(Oc1ccc(I)cc1)c1ccc(C#Cc2ccc(N(c3ccccc3)c3ccccc3)cc2)cc1 ; O=C(Oc1ccc(Br)cc1)c1ccc(C#Cc2ccc(N(c3ccccc3)c3ccccc3)cc2)cc1 ; O=C(Oc1ccc(Cl)cc1)c1ccc(C#Cc2ccc(N(c3ccccc3)c3ccccc3)cc2)cc1 ; CC#CC(C)(C)OC(=O)c1ccc(C#Cc2ccc(N(c3ccccc3)c3ccccc3)cc2)cc1] 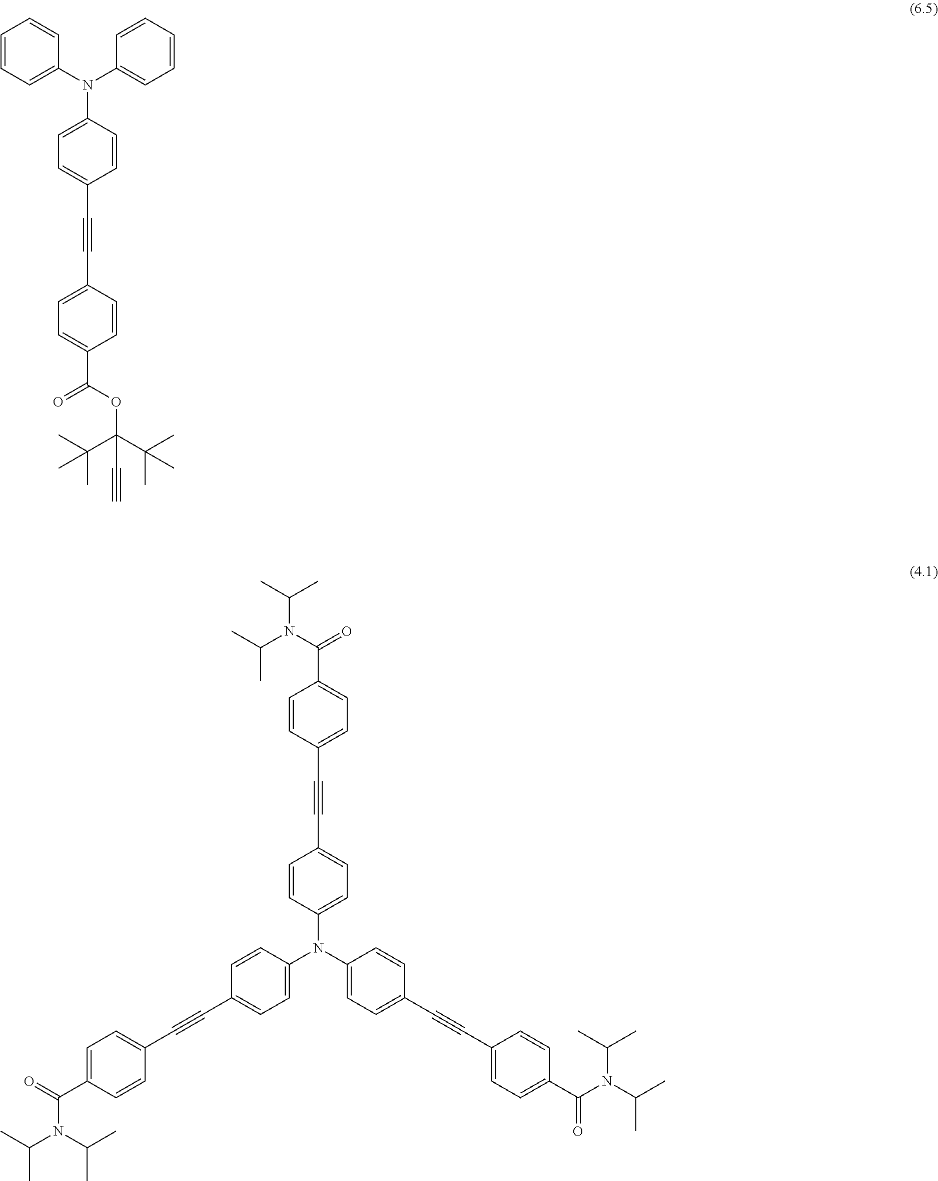 [SMILES: C#CC(OC(=O)c1ccc(C#Cc2ccc(N(c3ccccc3)c3ccccc3)cc2)cc1)(C(C)(C)C)C(C)(C)C ; CC(C)N(C(=O)c1ccc(C#Cc2ccc(N(c3ccc(C#Cc4ccc(C(=O)N(C(C)C)C(C)C)cc4)cc3)c3ccc(C#Cc4ccc(C(=O)N(C(C)C)C(C)C)cc4)cc3)cc2)cc1)C(C)C]
where the triphenylamine motif as a donor releases an electron to the NOₓ group of the analyte or as a receptor accepts an electron from the NOx group of the analyte, extinguishment of fluorescence of the detection reagent is measurable when the electron is released to the NOx group of the analyte, and/or regeneration or recovery of fluorescence is measurable when the electron is accepted, such that the analyte is optically determinable qualitatively and/or quantitatively.

7. Detection reagent according to claim 6, wherein the analyte comprising the NOₓ group is selected from: TNT, DNT, tetryl, PETN, NG, EGDN, DNDMB, ammonium nitrate, RDX and HMX.

8. Detection reagent according to claim 1, wherein the analyte comprising the NOx group is present in a sample comprising an organic solution, an aqueous solution, a mixed organic/aqueous solution, an air sample and/or a wiped sample.

9. Detection reagent according to claim 1, wherein R₁ and R₇ in the detection reagent are selected from CO₂X and PhCO₂X with X=4-iodophenyl;
4-bromophenyl; 4-chlorophenyl; 4-vinylphenyl or 4-allylphenyl and the detection reagent, after a reaction with a reactive organosilane by means of Heck or metathesis reaction, is covalently bonded to a substrate and/or forms a monomolecular layer over at least parts of the substrate.

10. Detection reagent according to claim 1, wherein R₁ and R₇ in the detection reagent are selected from CO₂Y and PhCO₂Y with Y=2-methyl-3-pentyn-2-yl or 3-tert-butyl-4,4-dimethyl-1-pentyn-3-yl and the detection reagent has been adsorbed on at least parts of the substrate, where there is no polymer between substrate and adsorbed detection reagent.

11. Detection reagent according to claim 9, wherein the substrate comprises a silicatic material or is a silicate glass.

12. Detection reagent according to claim 9, wherein the reactive organosilane is selected from: a trimethoxysilane and/or a triethoxysilane and/or a dimethoxysilane and/or a diethoxysilane.

13. Detection reagent according to claim 12, wherein the trimethoxysilane is selected from: allyltrimethoxysilane; butenyltrimethoxysilane; vinyltrimethoxysilane or (styrylethyl)trimethoxysilane; (stilbenylethyl)trimethoxysilane; 3-(trimethoxysilyl)propyl methacrylate; trimethoxy(4-vinylphenyl)silane; (trimethoxysilyl)benzene; trimethoxy(2-phenylethyl)silane; octyltrimethoxysilane; propyltrimethoxysilane; (trimethoxysilyl)stilbene, or the triethoxysilane is selected from triethoxyvinylsilane; (3-chloropropyl)-triethoxysilane or the dimethoxysilane is selected from dimethoxydiphenylsilane, or the diethoxysilane is selected from diallyldiethoxysilane; methylvinyldiethoxysilane or allylmethyldiethoxysilane.

14. Method of detecting an analyte having an NOx group, comprising:
providing an analyte-sensitive layer on a silicatic substrate, comprising:
a detection reagent according to claim 1, bonded covalently to the silicatic substrate via at least one —Si—C— bond;
or
a detection reagent according to claim 1, bound adsorptively to the silicatic substrate, where the silicatic substrate does not comprise any polymer film, and the analyte-sensitive layer is provided by contacting a silicatic substrate with a detection reagent according to claim 1,
wherein the contacting for the detection reagent with R₁ and R₇ selected from CO₂X or PhCO₂X is effected under the conditions of a Heck reaction or metathesis reaction and the contacting for the detection reagent wherein R₁ and R₇ are selected from CO₂Y or PhCO₂Y comprises adsorbing the detection reagent from a solution of the detection reagent on the silicatic substrate;
interaction of the analyte comprising the NOx group with the analyte-sensitive layer;
measuring a fluorescence property of at least one section of the analyte-sensitive layer.

15. Method according to claim 14, further comprising:
heating and/or evaporating a defined amount of sample that potentially contains the analyte comprising the NOₓ group;
guiding a gas or gas mixture comprising the evaporated or heated defined amount of sample to the analyte-sensitive layer, such that the analyte comprising the NOₓ group can interact with the detection reagent;
ascertaining a composition and/or a concentration of the analyte comprising the NOₓ group using measurement data from a comparative measurement.

16. Method according to claim 14, further comprising:
regenerating the analyte-sensitive layer by contact with an NOx-free fluid, by baking it and/or by passing a flow of steam over it.

17. Method according to claim 14, wherein the fluorescence property is selected from:
a fluorescence quantum yield, a fluorescence lifetime, a decrease in fluorescence intensity or a quenching of fluorescence or an increase in fluorescence after a preceding quenching of fluorescence.

18. Method according to claim 14, wherein the measuring of the fluorescence property comprises direct detection of an electrical signal from at least one detector or forming of a quotient from electrical signals that are detected at different excitation wavelengths by at least one detector.

19. Method according to claim 14, wherein the fluorescence property is measured with a portable, preferably handheld, measurement device, and the measurement device comprises a scanning device set up to measure the fluorescence property at at least one fixed wavelength.

20. Method according to claim 14, wherein the detection reagent is covalently bonded to the silicatic substrate at least via a —C—Si—C— bond and a surface concentration of the detection reagent of the analyte-sensitive layer is selected from 50-350 μmol/cm²; or the detection reagent described in one of claims 1 to 13 has been adsorbed on the silicatic substrate, where the surface concentration thereof on the substrate is between 100-750 μmol/cm².

21. Method according to claim 14, wherein the analyte is an explosive.

22. Production method for an analyte-sensitive layer on a silicatic substrate, comprising:
providing the silicatic substrate;
contacting the detection reagent according to claim 1 with the silicatic substrate.

23. Production method according to claim 22, wherein the providing of the silicatic substrate comprises:
activating the silicatic substrate, comprising treating the silicatic substrate with a mixture comprising hydrogen peroxide and sulfuric acid; and
silanizing the activated silicatic substrate with an organosilane.

24. Production method according to claim 22, wherein the contacting of the detection reagent with the silicatic substrate for the detection reagent with R₁ and R₇=CO₂X or PhCO₂X is preceded by silanizing of the detection reagent with an organosilane bearing a double bond, wherein the organosilane is present in an equimolar amount or in a molar excess, such that a silanization product or a silanization reaction mixture is contacted with the silicatic material.

25. Production method according to claim 23, wherein the organosilane is selected from: a trimethoxysilane and/or a triethoxysilane and/or a dimethoxysilane and/or a diethoxysilane.

26. Production method according to claim 25, wherein the trimethoxysilane is selected from: allyltrimethoxysilane; butenyltrimethoxysilane; vinyltrimethoxysilane; (trimethoxysilyl)stilbene or (styrylethyl)trimethoxysilane; (stilbenylethyl) trimethoxysilane; 3-(trimethoxysilyl)propyl methacrylate; trimethoxy(4-vinylphenyl)silane; (trimethoxysilyl)benzene; trimethoxy(2-phenylethyl)silane; octyltrimethoxysilane; propyltrimethoxysilane, or the triethoxysilane is selected from triethoxyvinylsilane, or (3-chloropropyl)triethoxysilane, or the dimethoxysilane is selected from dimethoxydiphenylsilane, or the diethoxysilane is selected from diallyldiethoxysilane, methylvinyldiethoxysilane or allylmethyldiethoxysilane.

27. Production method according to claim 22, wherein the silicatic substrate provided has a flat surface, for example is a pane, and the detection reagent is contacted with the silicatic substrate at least in parts on one side and/or in parts on both sides.

28. Production method according to claim 22, wherein the silicatic substrate has a curved surface at least in parts and encloses a cavity having at least one entry opening for an analyte feed and at least one exit opening for the analyte removal.

29. Production method according to claim 22, wherein the contacting is effected by dipping or using a spin-coater, a spray-coater, a piezoelectric metering system, a printer, a nanoplotter, an inkjet printer, or a die.

30. Production method according to claim 22, wherein the silicatic substrate is selected from a silicate glass, a borosilicate glass, a quartz glass, a silicon wafer, a polycrystalline silicon, a silicate nanoparticle and/or a silicon-containing ceramic.

31. Analyte-sensitive layer for an analyte comprising an NOx group, comprising:
a silicatic substrate,
a detection reagent arranged directly, without involvement of a polymer layer, on the silicatic substrate, wherein the detection reagent is selected from a substance of one of the formulae 1 to 5: 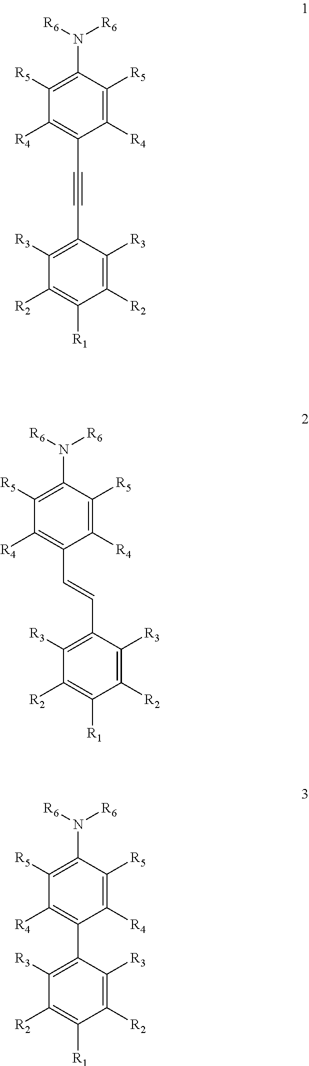 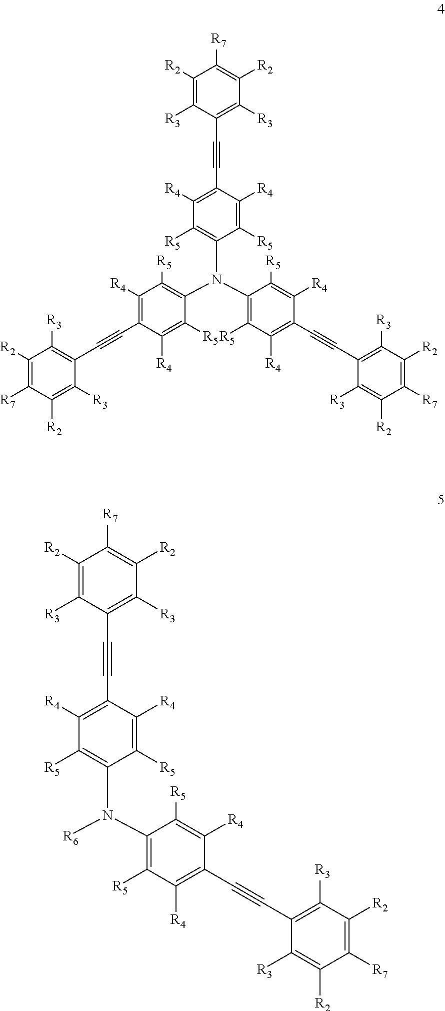
where
R₁ and R₇ are selected from CO₂X or PhCO₂ with X=4-iodophenyl; 4-bromophenyl, 4-chlorophenyl, 4-vinylphenyl
or
4-allylphenyl;
or
R₁ and R₇ are selected from CO₂Y or PhCO₂Y with Y=2-methyl-3-pentyn-2-yl or 3-tert-butyl-4,4-dimethyl-1-pentyn-3-yl;
or
R₇ is selected from CO₂Z, PhCO₂Z, C(O)NZ₂ or PhC(O)NZ₂ with Y=alkyl, perfluoroalkyl, vinyl, allyl, homoallyl, aryl;
where
R₂, R₃, R₄ and R₅ are independently selected from: H, F, alkyl, aryl; and
R₆ is selected from alkyl or aryl,
wherein the detection reagent is covalently bonded to the silicatic substrate at least via a —C—Si—C— bond and a surface concentration of the detection reagent on the analyte-specific layer is selected from 50-350 μmol/cm²; or
the detection reagent has been adsorbed on the silicatic substrate, where its surface concentration is between 100-750 μmol/cm², and
wherein a fluorescence intensity of the detection reagent in the presence of the analyte changes with respect to a fluorescence intensity of the detection reagent in the absence of the analyte as a function of a concentration of the analyte.

32. Analyte-sensitive layer according to claim 31, wherein
the analyte comprising the NOx group is selected from TNT, DNT, tetryl, PETN, NG, EGDN, NH₄NO₃, RDX and HMX.

33. Use of a detection reagent according to claim 1 for monitoring a threshold of an explosive.
